(19) United States
(12) Patent Application Publication
(10) Pub. No.: US 2022/0098420 A1
(43) Pub. Date: Mar. 31, 2022

(54) RHEOLOGY-CONTROLLABLE ANTI-CORROSION AGENT WITH AN AQUEOUS BASE

(71) Applicant: Pfinder KG, Boeblingen (DE)

(72) Inventors: Daniel GRUSECK, Sindelfingen (DE); Hans-Joerg WENZEL, Stuttgart (DE); Markus BUECKER, Stuttgart (DE); Christian SCHALLER, Neuhausen (DE)

(21) Appl. No.: 17/541,617

(22) Filed: Dec. 3, 2021

Related U.S. Application Data
(63) Continuation of application No. PCT/EP2020/065000, filed on May 29, 2020.

(30) Foreign Application Priority Data
Jun. 7, 2019 (DE) 10 2019 115 604.1

(51) Int. Cl. C09D 5/08; C09D 7/20; C09D 7/63; C09D 7/65; C09D 125/14

(52) U.S. Cl. CPC C09D 5/08; C09D 7/20; C09D 125/14; C09D 7/65; C09D 7/63

(57) ABSTRACT

The invention relates to an anti-corrosion agent with an aqueous base and a method for the production thereof. The water-based anti-corrosion agent is a cavity preservation agent, a means for underbody protection coating, a means for permanent storage and transport protection coating, or a means for temporary storage and transport protection coating, wherein the anti-corrosion agent is provided for anti-corrosion protection for a component, in particular a motor vehicle component, wherein the anti-corrosion agent can be applied cold, is reversibly gelling and physically drying, even in thick layers, is rheologically controllable and can be adjusted in an application-oriented manner.

### CROSS-REFERENCE TO RELATED APPLICATIONS

This application is a continuation of international patent application PCT/EP2020/065000, filed on May 29, 2020, designating the U.S., which international patent application has been published in German language and claims priority from German patent application 10 2019 115 604.1, filed on Jun. 7, 2019. The entire contents of these priority applications are incorporated herein by reference.

### BACKGROUND

The present invention relates to an anticorrosion composition on an aqueous basis and to a method for its production. The water-based anticorrosion composition is a cavity preservative composition, a composition for underbody protective coating, a composition for permanent storage and transit protective coating or a composition for temporary storage and transit protective coating, the water-based anticorrosion composition being intended for corrosion protection on a component, more particularly an automotive part, where the water-based anticorrosion composition can be applied cold, is reversibly gelling and physically drying, even in thick layers, and is rheologically controllable, adjustable according to utility.

Aqueous cavity preservation is a water-based system for corrosion control in cavities in vehicle construction. The regions situated within the shadow of the field lines in particular, such as plate doublings, flanges, rigs or otherwise-joined metal components, enjoy corrosion control, by the electrophoretically deposited coating material (CDC) that is inadequate or entirely absent. At these points the substrate surfaces, because of the wet-chemical pretreatment (activation), are in general bare and therefore highly reactive.

The corrosion control effect of the aqueous cavity preservation is based on a barrier effect of the dry film on the basis of a high hydrophobicity, which is realized through the use of oils and waxes. In order to combine these lipophilic components with the water to form the aqueous cavity preservation, emulsifiers are used.

The aqueous cavity preservative is a technical emulsion whose specific rheological properties are vital to the above utility. Characteristics of this system accordingly are the thixotropic quality and the reversibly relaxation behavior of the aqueous cavity preservative after compressive and shearing loading. These are the two qualities essentially which predestine the aqueous cavity preservative for its intended use in cavities. As a result of interaction-induced gelling of the liquid phase, the aqueous cavity preservative possesses an extreme long-term stability and can be stored for long periods without separating or displaying other emulsion-altering events Gruseck D. (2018): Study of the rheology and filming of a water-based anticorrosion system using a wax dispersion as example, dissertation, University of Paderborn). As a result of mechanical loading via the periphery to the applicator, and the subsequent atomization, the gel undergoes virtually complete liquefaction and the viscosity drops significantly, as is evident from FIG. 1.

This figure reveals the decrease in the viscosity with rising shear rate to \dot{γ}=1000 s⁻¹. As a result, structures present formerly are almost completely destroyed by shearing. This property is extremely important for the subsequent penetration into very small gaps and folds. Excesses run off from the body again via drainage holes introduced during construction.

Since, however, an appropriate residual amount for filming must remain within the component, the system possesses the characteristics of an increase in structure after mechanical or compressive loading. Only a balanced ratio of waxlike body substances, functional waxes, binders and diverse surface-active substances makes it possible for a mixture of this kind to be formulated stably.

DE 195 41 907 A1 discloses a method for producing waxlike and/or bitumenlike coatings, characterized by electrodeposition of an ionically stabilized aqueous dispersion of wax and/or bitumen and/or waxlike and/or bitumenlike substances on an electrically conductive substrate which is immersed into the dispersion, where the resultant coating melts or sinters as a result of heating, to form a coherent surface, after the substrate has been removed from dispersion and optionally rinsed.

CN 106800784 A discloses a composition for corrosion control in the automotive sector that comprises 1-10 wt % of a waxlike material, 1-20 wt % of an unsaturated resin, 1-20 wt % of a highly basic sulfonate, 1-5 wt % of an antirust pigment, 3-8 wt % of a surface-active agent and 40-70 wt % of water.

A disadvantage of the aqueous cavity preservatives known from the prior art is that it is not readily possible to adapt relevant product properties, especially the viscosity and/or shear rate, in accordance with the specific application or customer requirement. The approach involving the conventional production of dual systems or ternary systems, the latter consisting of water, oil phase and surfactants, is not purposively in the present case. Simplifying the formulation does not provide any results as regards finding causes for the system characteristics. The dispersions obtained in such ways have none of the desired properties or are unstable from the outset.

### SUMMARY

It is an object of the present invention, therefore, to provide aqueous cavity preservatives and a method for producing aqueous cavity preservatives whose properties can be readily adapted to the particular application, especially in accordance with the geometry of the component to be coated, and/or to customer requirement. A further object of the present invention lies in the provision of an aqueous cavity preservative and of a method for producing aqueous cavity preservatives that can be adapted to (existing) technical circumstances for the application of cavity preservatives, examples being coating lines at customer premises, and which therefore require alternatively no change, only minor changes or, indeed, a simplification of the technical circumstances.

In accordance with the invention, the objects stated above are achieved through provision of a water-based anticorrosion composition. The water-based anticorrosion composition is a cavity preservative composition, a composition for underbody protective coating, a composition for permanent storage and transit protective coating, or a composition for temporary storage and transit protective coating, the water-based anticorrosion composition being intended for corrosion control on a component, more particularly an automotive part, where the water-based anticorrosion composition can be applied cold, is reversibly gelling and physically drying, even in thick layers, and is rheologically controllable, adjustable according to utility.

The objects of the present invention as stated above are further achieved by the provision of a water-based anticorrosion composition. The water-based anticorrosion composition, optionally in accordance with the water-based anticorrosion composition stated in the paragraph above, comprises or consists of:

0.1 to 10.0 wt % of a surface-active additive,

0.0 to 5.0 wt %, e.g. 0.1 to 5.0 wt %, of a functionalized wax,

1.0 to 40.0 wt % of an organic binder,

0.1 to 15.0 wt % of an anticorrosion additive,

10.0 to 60.0 wt % of fully demineralized water (FDVV),

1.0 to 40.0 wt % of an oil,

1.0 to 20.0 wt % of a wax or waxlike substance,

0.0 to 5.0 wt %, e.g. 0.1 to 5.0 wt %, of a neutralizing agent,

0.0 to 5.0 wt %, e.g. 0.1 to 5.0 wt % of a pH stabilizer, and

0.0 to 2.0 wt %, e.g. 0.1 to 2.0 wt %, of a biocide, based on 100 wt % of the water-based anticorrosion composition.

The objects of the present invention as recited above are additionally achieved by the provision of a method for producing a water-based anticorrosion composition having a desired viscosity (η) and/or desired travel distance (TD). The method comprises or consists of: mixing 0.1 to 10.0 wt % of a surface-active additive; 0.0 to 5.0 wt % of a functionalized wax; 1.0 to 40.0 wt % of an organic binder; 0.1 to 15.0 wt % of an anticorrosion additive; 10.0 to 50.0 wt % of fully demineralized water (FDVV); 1.0 to 40.0 wt % of an oil; 1.0 to 20.0 wt % of a wax or waxlike substance; 0.0 to 5.0 wt % of a neutralizing agent; 0.0 to 5.0 wt % of a pH stabilizer; and 0.0 to 2.0 wt % of a biocide, based on 100 wt % of the water-based anticorrosion composition.

Employed preferably as solvent in the aqueous cavity preservative of the invention are only polar solvents, and more preferably water is the only solvent employed. The aqueous cavity preservative of the invention is therefore substantially free from nonpolar solvents—for example, less than 0.1 wt %, less than 0.5 wt % or less than 0.01 wt % of a nonpolar solvent is present (based on 100 wt % of the water-based anticorrosion composition). “Substantially free of nonpolar solvents” therefore signifies the possible presence of small amounts of nonpolar solvents, owing for example to the preparation of the components and their decomposition.

As part of the present invention, the system of the aqueous cavity preservative was characterized with regard to its developed properties and modeled mathematically using statistical design of experiment (DoE). Accordingly it became possible to tailor rheological properties of the aqueous cavity preservative by way of certain raw materials and variation of the amounts thereof in the range of ±20 wt %. Optimization based on target variables is possible in this way.

The rheology-determining variables of viscosity and/or travel distance of the aqueous cavity preservative are dependent on multiple constituents of the composition in such a way that studying the influence exerted by just two or three formulation components on the stated target variables is not purposive. It has been found, conversely, that a multiplicity of constituents have an effect on the viscosity and/or travel distance of the aqueous cavity preservative.

The key influencing variables were determined as part of a study by means of main effects diagram into the variables influencing the target variable of viscosity or travel distance, respectively (Gruseck D. (2018): Study of the rheology and filming of a water-based anticorrosion system using a wax dispersion as example, dissertation, University of Paderborn). As well as the main effects from looking at the formulation components individually, interactional relationships come increasingly to the fore. This was possible accordingly for the first time through the use of statistical techniques. For the viscosity, therefore, the following relationships arise: functionalized wax*surface-active additive; surface-active additive*pH stabilizer; anticorrosion additive 1*anticorrosion additive 2; anticorrosion additive 2*pH stabilizer.

From the paired components it is possible to derive the following interactional relationships in the case of which, when the concentration of one component alters, a change in the concentration of the other components has a contrary effect: functionalized wax*surface-active additive, surface-active additive*pH stabilizer, anticorrosion additive 1*anticorrosion additive 2, and anticorrosion additive 1*pH stabilizer.

This produces the regression equation for the viscosity η (as per equation 1):

η [mPa*s]=47.811 [mPa*s]+4.788 [mPa*s*g⁻¹]*(starting weight of functionalized wax [g])+6.040 [mPa*s*g⁻¹]*(starting weight of surface-active additive [g])+3.895 [mPa*s*g⁻1]*(starting weight of anticorrosion additive 1 [g])+1.389 [mPa*s*g⁻¹]*(starting weight of pH stabilizer [g])+0.798 [mPa*s*g⁻¹]*(starting weight of anticorrosion additive 1 [g])+1.629 [mPa*s*g⁻²]*(starting weight of wax or waxlike substance [g]*starting weight of surface-active additive [g])−0.888 [mPa*s*g⁻²]*(starting weight of surface-active additive [g]*starting weight of pH stabilizer [g])+1.018 [mPa*s*g⁻²]*(starting weight of anticorrosion additive 1 [g]*starting weight of anticorrosion additive 2 [g]). (equation 1)

The viscosity in this case is preferably =50 mPa*s with a possible deviation of ±10 mPa*s. More preferably the deviation is ±9 mPa*s, ±8 mPa*s, ±7 mPa*s, ±6 mPa*s, ±5 mPa*s, ±4 mPa*s, ±3 mPa*s, ±2 mPa*s or ±1 mPa*s.

Equation (1) is determined at room temperature, preferably at a temperature of 23° C., with a rheometer at constant shear rate. The instrument used is preferably an MCR 302 rheometer (Anton Paar, Austria) with associated cylinder measuring system, which is used according to manufacturer details. The shear rate is kept constant at \dot{γ}=1000 s⁻¹.

The following interactions arise for the target variable of travel distance: functionalized wax*surface-active additive; and also functionalized wax*anticorrosion additive 1 as contrary relations.

From this the regression equation for the travel distance as per equation 2 is obtained as follows:

TD=17.18−2.325*(functionalized wax)−6.625*(surface-active additive)+4.70*(functionalized wax)²−1.625*(functionalized wax*surface-active additive)

TD=17.18−2.325*[cm*g⁻¹]*(starting weight of functionalized wax [g])−6.625 [cm*g⁻¹]*(starting weight of a surface-active additive [g])+4.70*[cm*g⁻²]*(starting weight of functionalized wax [g])²−1.625 [cm*g⁻²]*(starting weight of functionalized wax [g]*starting weight of surface active additive [g]). [equation 2]

The travel distance in this case is preferably TD=25 cm with a possible deviation of ±5 cm. More preferably, the possible deviation is ±4 cm, +3 cm, +2 cm, ±1 cm, ±0.5 cm, ±0.1 cm or ±0.01 cm.

Equation (2) is determined at room temperature, preferably at a temperature of 23° C., and at a relative humidity of φ=50%±5%. The travel distance may be determined, for example, using a tape measure or performing a laser measurement of distance.

As a further descriptive parameter of the aqueous cavity preservative it is possible to employ the loss factor tan δ. In rheology this factor designates the ratio between loss modulus G″ (imaginary component) and storage modulus G′ (real component). A high loss factor therefore indicates a behavior which approximates, in accordance with tan δ=G″/G′, to an ideally-viscous liquid with newton flow behavior. A low loss factor, conversely, indicates approximation to the behavior of an ideally-elastic solid. The loss factor tan δ can therefore likewise be employed in order to describe the possible gel-like nature of the aqueous cavity preservative, etc.

The loss factor tan δ is subject to equation 9:

tan δ[ ]=0.5936 [ ]−0.0215 [g⁻¹]*(starting weight of functional wax [g])+0.0353 [g⁻¹]*(starting weight of surface active additive [g])−0.303 [g⁻¹]*(starting weight of anticorrosion additive [g])+0.0426 [g⁻¹]*(starting weight of pH stabilizer [g])−0.0962 [g⁻²]*(starting weight of functional wax [g]*starting weight of surface active additive [g])+0.0436*[g⁻²]*(starting weight of functional wax [g]*starting weight of pH stabilizer [g])−0.0529 [g⁻²]*(starting weight of surface-active additive [g])². [equation 9]

The loss factor here is preferably tan δ=0.5 with a possible deviation of ±0.2. More preferably the possible deviation is ±0.18, ±0.16, ±0.14, ±0.12, ±0.10, ±0.08, ±0.06, ±0.04, ±0.02 or ±0.01.

Equation (9) is valid for room temperature, preferably at a temperature of 23° C. The instrument used is preferably an MCR 302 rheometer (Anton Paar, Austria) with associated cylinder measuring system, which is used according to manufacturer details. The shear rate for the primarily shearing is kept constant at \dot{γ}=1000 s⁻¹. The tan δ is determined with a circular frequency ω=10 rad/s and a deformation of γ=5% by means of oscillation.

On the basis of these findings it is therefore possible for customer-specific or application-optimized materials to be developed and/or adjusted by varying the surface-active substances in the range of ±20 wt % and also by targeted substitution of the property-determining components with functionally analogous substances or preparations.

From the results of the target variable-specific system modeling it is then possible readily to derive a plurality of optimized and/or adapted compositions. A customer-specific materials setting is therefore provided according to the applicational requirements and the component geometries. By these means it is possible to achieve optimum coating via quantity adaptation and materials reduction, corresponding to fundamental sustainability and resource preservation. With knowledge of the effects exerted by the respective raw materials, it is also possible, then, to draw up further formulations as a function of the desired properties, and hence to improve and facilitate the development work.

The term “water-based anticorrosion composition” as used herein relates to an anticorrosion composition whose constituents are present in dispersion in an aqueous medium. The water content here is preferably 10.0 to 60.0 wt %, more preferably 10.0 to 50.0 wt %, e.g. 15.0 to 45.0 wt %, 20.0 to 40.0 wt %, 25.0 to 35.0 wt %, 27.5 to 34.0 wt %, 30.0 to 33.0 wt %, or 31.0 to 32.0 wt %, of fully demineralized water (FDVV), based on 100 wt % of the anticorrosion composition. This distinguishes the water-based anticorrosion composition from a solvent-based anticorrosion composition, in which a nonpolar organic solvent is used, and from solvent-free anticorrosion compositions.

The fully demineralized water may be, for example, singularly distilled water, multiply distilled water, deionized water (deionized by ion exchange, for example), or demineralized water. The preparation of the fully demineralized water is familiar to the skilled person. The conductivity of the fully demineralized water may be, for example, 5 mS/m or less, as for example 3 μS/m to 4 mS/m, 50 μS/m to 3 mS/m, 100 μS/m to 2 mS/m, 200 μS/m to 1 mS/m, 300 μS/m to 900 μS/m, 400 μS/m to 800 μS/m, 500 μS/m to 700 μS/m, or 600 μS/m to 650 μS/m.

For the water-based anticorrosion composition, the required increase in viscosity after application is achieved not only by the evaporation of the medium, i.e. of the water, but also by the development of superstructures in the form of gels, based on physical interactions. The evaporation is promoted for example by increase in temperature. This increase in temperature brings about drying of the water-based anticorrosion composition. After gelling of the anticorrosion composition and/or evaporation of the medium, a film is formed on the coated surface that provides protection from corrosion.

In the further course of the functioning of the water-based anticorrosion composition, good heat stability is necessary, so that when the component is reheated the filmed anticorrosion composition does not become liquid again and cannot run, and the integrity of the anticorrosion composition is ensured in a range from typically −20° C. to +105° C. In the case of the water-based anticorrosion composition, this integrity derives only to a small extent, preferably not at all, from a chemical crosslinking of the constituent components, such as the oxidative crosslinking or drying of alkyd resin, for example.

The water-based anticorrosion composition of the invention may be a cavity preservative composition, a composition for underbody protective coating, a composition for permanent storage and transit protective coating, or a composition for temporary storage and transit protective coating.

The water-based anticorrosion composition of the invention is intended preferably for corrosion protection of a component, more particularly an automotive part.

The water-based anticorrosion composition of the invention can preferably be applied cold and can therefore be applied at a temperature of 20° C. to 35° C., preferably at room temperature and hence at a temperature of 20° C. to 25° C., 21° C. to 24° C., or 22° C. to 23° C., to a component, for example.

The water-based anticorrosion composition of the invention is preferably reversibly gelling and physically drying. The term “reversibly gelling” here relates to a reduction in viscosity which occurs as a result of external influences, such as by temperature increase and/or mechanical loading, and therefore to an at least partial liquefaction of the water-based anticorrosion composition. The term “physically drying” relates to the filming of the aqueous cavity preservative by loss of the water present therein, preferably substantially without chemical crosslinking, and hence formation of covalent bonds, by any components contained in the aqueous cavity preservative.

The reversibly gelling and/or the physically drying nature of the aqueous cavity preservative is described preferably by means of one or more parameters, such as the viscosity η, the travel distance TD and the loss factor tan δ. Employed more preferably are two of the aforesaid parameters, even more preferably all three parameters.

The water-based anticorrosion composition of the invention, even in thick layers, is preferably rheologically controllable and also adjustable relative to utility. The term “thick layer” as used herein relates to layer thicknesses of 800 μm or more, e.g. 1000 μm to 6000 μm, 2000 μm to 4000 μm, or 3000 μm to 4000 μm. The layer thickness here is dictated by the coating method selected, preferably application with a doctor blade, and is not ascertained retrospectively by determining the layer thickness using a measurement method. The term “rheologically controllable” as used herein relates to the possibility of adjusting the viscosity and/or the travel distance of the water-based anticorrosion composition “relative to utility”, and therefore in line with customer requirements and/or technical circumstances. This adjustment to the viscosity and/or the travel distance, preferably to the viscosity and the travel distance, of the water-based anticorrosion composition is made here in particular within the ambit of equation 1 for the viscosity and equation 2 for the travel distance.

The water-based anticorrosion composition of the invention comprises 0.1 to 10.0 wt % of a surface-active additive, 0.0 to 5.0 wt % of a functionalized wax, 1.0 to 40.0 wt % of an organic binder, 0.1 to 15.0 wt % of an anticorrosion additive, 10.0 to 60.0 wt % of fully demineralized water (FDVV), 1.0 to 40.0 wt % of an oil, 1.0 to 20.0 wt % of a wax or waxlike substance, 0.0 to 5.0 wt % of a pH stabilizer, and 0.0 to 2.0 wt % of a biocide, based on 100 wt % of the anticorrosion composition.

A surface-active additive here relates to 1 surface-active additive or more, e.g. 2 to 5, or 3 to 4 surface-active additives. A functionalized wax here relates to 1 functionalized wax or more, e.g. 2 to 5, or 3 to 4 functionalized waxes. An organic binder here relates to 1 organic binder or more, e.g. 2 to 5, or 3 to 4 organic binders. An anticorrosion additive here relates to 1 anticorrosion additive or more, e.g. 2 to 5, or 3 to 4 anticorrosion additives. These may equally be an anticorrosion additive 1 and/or an anticorrosion additive 2. An oil here relates to 1 oil or more, e.g. 2 to 5, or 3 to 4 oils. A wax or waxlike substance here relates to 1 wax or waxlike substance or more, e.g. 2 to 5, or 3 to 4 waxes or waxlike substances. A neutralizing agent here relates to 1 neutralizing agent or more, e.g. 2 to 5, or 3 to 4 neutralizing agents. A pH stabilizer here relates to 1 pH stabilizer or more, e.g. 2 to 5, or 3 to 4 pH stabilizers. A biocide here relates to 1 biocide or more, e.g. 2 to 5, or 3 to 4 biocides.

The anticorrosion additive 1 and the anticorrosion additive 2 may be identical compounds. In that case it is likewise possible, rather than the term “anticorrosion additive 1” or “anticorrosion additive 2”, to use the term “anticorrosion additive”. Preferably the anticorrosion additive 1 and the anticorrosion additive 2 are different.

Where the water-based anticorrosion additive of the invention comprises two different anticorrosion additives, the anticorrosion additive present at a higher concentration is regarded preferably as anticorrosion additive 1, and the anticorrosion additive present at a low concentration is preferably regarded as anticorrosion additive 2. If the water-based anticorrosion additive of the invention should comprise three or more anticorrosion additives, then preferably the concentration of the third anticorrosion additive and of any further anticorrosion additive is added to the concentration of the anticorrosion additive 2. A combination consisting of amine derivatives (“anticorrosion additive 1”) and sulfonates (“anticorrosion additive 2”) is particularly preferred.

Where one of the components used in the water-based anticorrosion composition of the invention has two or more functions, selected from a surface-active additive, a functionalized wax, an organic binder, an anticorrosion additive, an oil, a wax or waxlike substance, a neutralizing agent, a pH stabilizer, and a biocide, or the component may be regarded as corresponding compounds on the basis of its properties, the assignment is made preferably in accordance with the functional order stated above. The component is therefore assigned preferably to the first-stated function (from the order stated above). For example, a component which may be regarded both as a surface-active anticorrosion agent and as an organic binder is regarded for the purposes of the present invention as a surface-active additive. Similarly, for example, a substance which may be regarded both as an oil and as a wax or waxlike substance is regarded for the purposes of the present invention as an oil. As mentioned above, this is also the case if the component should have more than two of the stated functions, e.g. 3, 4, 5 or more.

The term “surface-active additive” or “emulsifier” as used herein relates to an auxiliary whose purpose is to mix two mutually immiscible liquids, such as oil and water, for example, to form an emulsion and to stabilize said emulsion.

Suitable emulsifiers have the general formula R—(O—CH₂—CH₂—)ₓ—OH, where R is an alkyl radical, aryl radical, carboxylic acid radical or a derivative of a carboxylic acid radical, and 3≤x≤50 with x∈ [symbol] . Preferably 5≤x≤45, 10≤x≤40, 15≤x≤35, or 20≤x≤30.

According to yet a further preferred embodiment of the present invention, the surface-active additive is selected from the group consisting of a nonionic emulsifier, an alkylcarboxylate, an alkylbenzenesulfonate, or an alkyl ether sulfate, the nonionic emulsifier having the general formula R—(O—CH₂—CH₂—)ₓ—OH, where R is an alkyl radical, aryl radical, carboxylic acid radical or a derivative of a carboxylic acid radical, and 3≤x≤50 with x∈ [symbol] .

The term “wax” as used herein relates to an organic compound which melts at 40° C. and then forms a liquid with a low viscosity. Waxes are virtually insoluble in polar solvents, such as water, but soluble in organic, nonpolar solvents.

Polar and nonpolar solvents respectively are defined for the purposes of the present invention by way of the E_{T}(30) or E_{T}^{N} scale. Corresponding values can be taken from the literature. Polar solvents preferably have an E_{T}(30) of ≥200 kJ/mol, while nonpolar solvents preferably have an E_{T}⁽³⁰⁾ of <200 kJ/mol. E_{T}(30) values for various solvents can be taken for example from the literature, or from the web page https://www.uni-marburg.de/fb15/ag-reichartdt/et_home. An illustrative polar solvent is a solvent having a polarity of 1-octanol or more polar, such as butanol or propanol.

The waxes used in the context of the present invention are synthetic and/or natural in origin, with preferably at least one waxlike substance being paraffinic in nature. Suitable waxes may be taken from L. Ivanovszky (1954): Wachsenzylkopadie [Wax Encyclopedia] volume 1, Augsburg: Verlag für chemische Industrie H. Ziolkowsky K. G.

The waxes may be microwaxes or microcrystalline waxes, e.g. finely crystalline paraffin. In comparison to paraffinic waxes, which contain primarily unbranched alkanes, a microcrystalline wax has a higher proportion of isoparaffinic hydrocarbons. Microcrystalline waxes preferably have solidification points of between 70° C. and 80° C. and contain up to 75 carbon atoms.

A “functionalized wax” or “functional wax” embraces waxes, microcrystalline waxes for example, which carry chemically functional groups, preferably one or more of a carboxyl group, carbonyl group, hydroxyl group; and ester or pseudo ester group, thiocarboxyl group, thiocarbonyl group, thiol group; and thioester or pseudo thioester group. A pseudo ester group or pseudo thioester group here constitutes an isomeric form of the ester group or thioester group, respectively. There is no limit here on the number of chemically functionally groups.

The carboxyl group and/or thiocarboxyl group-functionalized waxes are preferably neutralized before or during preparation. For this purpose it is possible to use monovalent and/or polyvalent cations, especially alkali metal ions and/or alkaline earth metal ions, in a hydroxyl compound. The resultant wax soaps then act as surface-active substances and/or corrosion inhibitors. Other information in this regard may be taken from Costello M. T. (2008): Corrosion Inhibitors and Rust Preventatives in Leslie R. Rudnick; Lubricant Additives, Chemistry and Applications 2^{nd} Revised edition, Boca Raton, Fla.: CRC Press Taylor and Francis Group, pp. 420-431.

“Organic binders” in the sense of this invention are understood as resins as are set out in Zorll, U. (1998): Römpp Lexikon-Lacke and Druckfarben, Stuttgart: Thieme and, respectively, Barendrecht, W., Collin, G., Dunlop, A. P., McKillip, W. J., Winner, J., Stoye, D., Allwinn, R., Griebsch E. (1976): Harze, synthetische [Resins, synthetic] in: Bartholomé E., Biekert, E., Hellmann, H., Ley, H., Weigert, W. M. Ullmanns Enzylopädie der technischen Chemie 4^{th} edn. vol. 12 Fungizide bis Holzwerkstoffe [Fungicides to Wood Materials], Weinheim: Verlag Chemie, pp. 539-555.

Preferred organic binders are hydrocarbon resins (Zorll U. (1998): Römpp Lexikon-Lacke and Druckfarben, Stuttgart: Thieme). Hydrocarbon resins have more preferably an average molar mass in the range of 300-2000 g/mol, e.g. 500-1500 g/mol, or 750-1000 g/mol, and/or a density of between 0.9 g/cm³-1.2 g/cm³. In general the hydrocarbon resins are readily soluble in nonpolar solvents, such as ethers, esters, ketones and chlorinated and halogen-free hydrocarbons.

The hydrocarbon resins embrace resins from petroleum, or petroleum resins; resins from coal tar; and terpene resins. Petroleum resins are preferred. The production of these resins is known to the skilled person.

Specific properties, more particularly polar functional groups, can be installed in the frequently nonpolar and low-functionality hydrocarbon resins by way of corresponding modification, as for example via the copolymerization of unsaturated hydrocarbon resins with phenol. Modified hydrocarbon resins of these kinds are particularly preferred on account of better solubility in water.

Further preferred organic binders are styrene-acrylate polymer dispersions. These are set out for example in Müller, B., Poth, U. (2009): Lackformulierung & Lackrezeptur [Paint formulation], Hannover: Vincentz Network Group GmbH & Co; Goldschmidt A, H. J. Streitberger (2014): BASF Handbuch der Lackiertechnik [Handbook of Coating Technology], 2^{nd} edition, Hannover: Vincentz Network GmbH & Co., Thieke, B. (1997): Makromolekulare Chemie—Eine Einführung [Macromolecular Chemistry—An Introduction], 1st edition, Weinheim: VCH Verlagsgesellschaft mbH; Poth, U.; Schwalm; R., Schwartz, M. (2011): Acrylatharze [Acrylate resins], Hannover: Vincentz Network, and Diestler, D. Eidam, N., Kirchner, W. Kuropka, R., Lanman, A., Lutz, H., Müller G., Petereit, H. U., Prantl, B., Schmidt-Thümmes, J., Schwarzenbach, E., Schwenzfeier, H,-P., Sülfke, T., Urban, D., Wiese, H., Wistuba, E, (1999): in Diestler D., Wässrige Polymerdispersionen [Aqueous Polymer Dispersions], Weinheim: Wiley-VCH Verlag GmbH, pp. 1-30; Brock, T., Groteklaes, M., Mischke, P. (1998)—Lehrbuch der Lacktechnologie [Textbook of Coating Technology], Hannover: Curt R. Vincentz Verlag.

These copolymers may be produced for example via emulsion polymerization from the monomers of acrylic esters and styrene in aqueous solution by way of radical polymerization. The emulsion polymerization is familiar to the skilled person and may be used for example in order to generate monodispersions. These monodispersions commonly have an average particle size D50 of between 0.05 and 0.8 μm, which may be determined by means of conventional laser diffractometry, preferably according to ISO 13320:2009.

Specifically for air-drying systems and systems which crosslink at room temperature, preference is given to using particularly volatile types such as ammonia, and also representatives of the primary or secondary amines, in order to enable neutralization of the binder and establishment of a desired pH of 6 to 9, for example.

Heterogeneous dispersions, in which the particles combine two polymer phases in themselves, are generally notable for a high blocking resistance, and are preferred as organic binders. These dispersions preferably form only ideal spherical polymer particles and may be distinguished by a multiplicity of differently structured latex particles.

Such core-shell systems or core-shell colloids constitute particularly preferred organic binders. To prepare them, a comparatively soft polymer is polymerized or grafted onto a second, comparatively harder polymer particle. In the case of staged polymerization, the particle morphology is commonly dependent on both thermodynamic and kinetic factors, and also on the composition/proportion of the two phase-forming polymers.

These core-shell systems are produced in accordance with emulsion polymerization via two stages with separate addition of monomer. A peculiarity of this type is what are called the inverse core-shell particles. Here there is a reversal of the positioning of the phases, so that the polymer formed in stage 1 is identifiable as shell material at the end of the preparation process.

For the purposes of the present invention, therefore, a binder which films preferably at room temperature and whose type is that of an inverse core-shell particle is used.

Stabilization is accomplished presumably via the positioning of polymeric structures on the particle surface, which takes place in the form of a graft polymerization in the emulsion. As a result of this process, the “shell structure” has a corresponding polar design, enabling it to accommodate water molecules, and it then functions as a “plasticizer”. This gel is able to dry in air, without releasing organic solvents, and the polymer beads are able to film via interfacial interdiffusion. This dispersion is self-crosslinking.

The term “anticorrosion additive” or “corrosion inhibitor” as used herein relates preferably to inhibitors, in the form of organic molecules, for example, which adsorb onto a surface of a substrate and thus block possible reactions with the surrounding environment. Especially in the region of metallic substrates, therefore, they prevent corrosion initiated by exposure to atmospheric oxygen. More on this can be taken from Costello M. T. (2008): Corrosion Inhibitors and Rust Preventatives in Leslie R. Rudnick; Lubricant Additives, Chemistry and Applications 2^{nd} Revised edition, Boca Raton, Fla.: CRC Press Taylor and Francis Group, pp. 420-431 or Bieleman J. (1998): Lackadditive [Additives for Coatings], Weinheim: WILEY-VCH Verlag GmbH.

In the context of the present invention, preference is given to employing chemical corrosion inhibitors, especially chemisorbents, passivators and topcoat formers, and possibly physical corrosion inhibitors as well.

The corrosion inhibitor ought to be freely mobile, which contradicts “coupling” to the binder, or should not be tied into the matrix during the crosslinking reaction. The molar mass of the corrosion inhibitor for this purpose is preferably 600 g/mol or less, e.g. 500 g/mol or less, 400 g/mol or less, 300 g/mol or less, or 150 to 250 g/mol.

In coatings, inhibitors are used for protection against atmospheric corrosion (weakly acidic to weakly alkaline media in the presence of oxygen). These inhibitors may be basic compounds such as organic bases, amines or amine derivatives, organic acids or salts thereof, especially carboxylic acids or carboxylic salts, phenol-carboxylic acids, such as tannin, for example, nitrocarboxylic acids, basic plasticizers, organic chromium compounds, and organic compounds with oxidizing activity. A further possibility is to use organic chromium compounds, examples being organic chromates, phosphates phosphites, phosphonic acid derivatives and arsenic acid derivatives, which exhibit good inhibitor effect by virtue of the inorganic fractions and ensure effective incorporation into the binder by way of the organic component.

Typically anticorrosion additives in coatings technology are the sulfonates. The parent sulfonic acids may be prepared from hydrocarbons and SO₃, for example.

It is additionally possible to use sulfonates, especially petroleum sulfonates, for corrosion control. A distinction is made generally between natural and synthesis sulfonates. The oil solubility or water solubility of the subsequent product is adjusted by way of the chain length. The sulfonates take the form, for example, of Na, Ca, Mg or Ba sulfonates. Sulfonates with relatively high molar masses are preferred. These sulfonates have alkyl chains of C16 or more, e.g. C20 to C50, C25 to C45, or C30 to C40.

These basic detergents are also available in an “overbased or superbasic” form and may be used as an anticorrosion additive (in this regard see overbased sulfonate preparations according to Bieleman J. (1998): Lackadditive [Additives for Coatings], Weinheim: WILEY-VCH Verlag GmbH). They act positively on the uncomplicated incorporation of this raw materials group into coating materials, and also represent a possibility for targeted adjustment of the running behavior.

As well as the properties of stabilizing dispersions through a thickening effect, the overbased formulations, according to Costello M. T. (2008): Corrosion Inhibitors and Rust Preventatives in Leslie R. Rudnick; Lubricant Additives, Chemistry and Applications 2^{nd} Revised edition, Boca Raton, Fla.: CRC Press Taylor and Francis Group, pp. 420-431, possess outstanding corrosion control. They are therefore included in the group of physical corrosion inhibitors.

The petroleum sulfonates are products of petroleum refining according to Gerhard C. (1979): Petrolsulfonate [Petroleum Sulfonates], in: Bartholomë E., Biekert E., Hellmann H., Ley H., Weigert W. M. Ullmans Enzyklopädie der technischen Chemie 4. edn. Vol. 18 Petrolsulfonate bis Plutonium [Petroleum Sulfonates to Plutonium], Weinheim: Verlag Chemie, pp. 1-2.

The corrosion inhibitors particularly preferred for the invention described here come from the groups of the carboxylic acids and derivatives thereof, primarily the groups of the phenol sulfonic acids, and also of the amines, amine derivatives and/or reaction products thereof.

An “oil” as used herein is a collective designation relating to organic compounds with similar physical properties, according to Zorll, U. (1998): Römpp Lexikon-Lacke and Druckfarben, Georg Thieme Verlag Stuttgart. These compounds are insoluble in water and possess a low vapor pressure, which may be regarded as the key characteristics. Oils are subdivided in principle into three groups: a) mineral oils based on petroleum, fully synthetic oils; b) oils of animal or plant origin; and c) essential oils, these being oils and odorants of plant origin with corresponding volatility.

An oil is therefore differentiated from a “wax”, which according to L. Ivanovszky (1954): Wachsenzyklopädie [Wax Encylopedia] volume 1, Augsburg: Verlag für chemische Industrie H. Ziolkowsky K. G. and Ullmann, G. Schmidt, H. Brotz, W. Michalczyk; G. Payer, W. Dietsche, W. Hohner, G. Wildgruber, J. 1983: Wachse [Waxes], in Bartholomé E., Biekert, E., Hellmann, H., Ley, H., Weigert, W. M. Ullmanns Enzyklopädie der technischen Chemie 4th edn. vol. 24 Wachse bis Zündhölzer [Waxes to Matches], Weinheim: Verlag Chemie, pp. 1-49, is distinguished by simultaneous compliance with the following characteristics: kneadable at 20° C., solid to brittly hard; coarsely to finely crystalline, translucent to opaque, but not glassy; melting above 40° C. without decomposition; of relatively low viscosity just a little above the melting point; highly temperature-dependent in consistency and solubility; polishable under gentle pressure.

A “neutralizing agent” as used herein relates to agents for establishing a particular pH and/or pH range.

Preferred neutralizing agents are amines. The amine may be a primary, secondary or tertiary amine, preferably secondary or tertiary amine, more preferably a tertiary amine. Illustrative and preferred amines are set out below in relation to the pH stabilizer.

“A pH stabilizer” as used herein is used for stabilizing the pH to a target value, for example approximately pH 7.0, and/or to a target range, more particularly to a pH of 7.0 to 10.5, e.g. a pH of 8.0 to 10.0, 8.5 to 9.5, or 8.75 to 9.25. The pH stabilizer may in particular provide a buffer effect for a pH range.

An amine is preferably used as a pH stabilizer.

Amines are ideally suitable as neutralizing agents for carboxyl-containing components in a water-based anticorrosion composition. Additionally amines likewise contribute to the stabilization, especially of aqueous systems. This is accomplished through the development of ionogenic structures and the associated effect of charge formation. As a result, between the—for example—polymer droplets of a dispersion, there is electrostatic repulsion, which counteracts coagulation and benefits the stabilization of the system. This is assisted by associated hydration of the particles in aqueous media. In this regard, see Müller B., Poth U. (2009): Lackformulierung & Lackrezeptur [Paint Formulation], Hannover: Vincentz Network GmbH & Co., or Goldschmidt A., H. J. Streitberger (2014): BASH Handbuch der Lackiertechnik [BASF Handbook of Coating Technology], 2^{nd} edition, Hannover: Vincentz Network GmbH & Co.

The amine may be a primary, secondary or tertiary amine, preferably secondary or tertiary amine, more preferably tertiary amine.

The amine comprises various organic radicals, as for example a substituted or unsubstituted aryl radical and/or substituted or unsubstituted alkyl radical. The substituted or unsubstituted radicals may be of high molecular weight, with, for example, a molecular weight of 150 g/mol or more, e.g. 175 g/mol to 800 g/mol, 200 g/mol to 500 g/mol, or 300 g/mol to 400 g/mol, or of low molecular weight, with, for example, a molecular weight of less than 150 g/mol, e.g. 140 g/mol or less, 130 g/mol or less, 120 g/mol or less, 110 g/mol or less, 100 g/mol or less, 90 g/mol or less, 80 g/mol or less, or 70 g/mol or less. Illustrative substituents comprise a hydroxyl group or amino group. Thiol groups and/or halogen substituents are preferably not comprised.

For the purposes of the present invention, preference is given in particular to secondary or tertiary amines of low molecular weight, since they possess good water solubility. Furthermore, they can be evaporated during filming rapidly and completely or almost completely. This leads to destruction of the amphiphile formed in situ during the preparation. The previously neutralized groups are liberated, and without amine stabilization would tend toward coagulation. They can now coagulate in a targeted way via filming and they therefore additionally increase the water repellency of the coating and improve the water resistance.

Specifically for air-drying formulations which also film at room temperature it is an advantage to use especially volatile representatives of this class of compound, such as, for example, ammonia or dimethylamine (DMA).

Further suitable pH stabilizers include diethylamine, diethylethanolamine and 2-methyl-2-aminopropanol, which on account of their high boiling points are employed primarily in thermosetting systems. In particular, 2-methyl-2-aminopropanol is preferred on account of the comparatively mild intrinsic odor.

“Biocides” are combinations of active components for in-can preservation, these combinations being tailored to the particular problem scenario. Environmentally relevant pointers and information regarding their use can be found in REGULATION (EU) No. 528/2012: The making available on the market and use of biocidal products, OF THE EUROPEAN PARLIAMENT AND OF THE COUNCIL; 22 May 2012, and Hensel T. (2013): Biozide [Biocides], Annual Meeting BI, BG ETEM, 02.07.2013 and, concerning the paint-technology relevance, Goldschmidt A, H. J. Streitberger (2014): BASF Handbuch der Lackiertechnik [BASF Handbook of Coating Technology], 2^{nd} edition, Hannover: Vincentz Network GmbH & Co.; Brock, T. Groteklaes, M. Mischke, P (1998)—Lehrbuch der Lacktechnologie [Textbook of Coatings Technology], Hannover: Curt R. Vincentz Verlag.

Water-based substances in particular, and hence also the water-based anticorrosion composition of the invention, are potentially susceptible to infestation by microorganisms, examples being algae, fungi (yeasts) and bacteria. In order to avoid such contamination, it is necessary not only to design production correspondingly, with appropriate cleaning and disinfection cycles, but also to ensure that the system is protected through transit and in storage. In storage containers in particular, microbial contamination may lead to fouling. Depending on the type of microbe, this fouling is also accompanied by a change in the coloration of the product surface. Furthermore, breakdown products and metabolic products of the microbes can lead to irreversible systematic changes such as pH changes, deterioration in rheological behavior, coagulation, breaking of dispersions, evolution of gas, or rotting.

Since virtually all biocides have a certain gap in relation to their activity against particular organisms, it is common to use a plurality of active ingredients. Synergistic effects which occur in such cases can be exploited through a targeted combination of compounds from the respective substance classes.

The selection of the biocide is guided by the requirements with regard to the finished product and by the mechanisms of the microbial activity of the substances.

Preference is given to using benzalkonium chloride, benzoic acid, glutaraldehyde, a formaldehyde donor and an isothiazolinone, alone or in combination.

Illustrative and preferred formaldehyde donors include benzylhemiformal, 1,6-dihydroxy-2,5-dioxahexane, methylolurea, 7-ethylbicyclooxazoline, urotropin, paraformaldehyde, tris(hydroxymethyl)nitromethane.

Isothiazolones are compounds from the area of heterocycles and are commonly characterized by way of their substituents. Employed for example and preferably are isothiazolinone, methylisothiazolinone, chloromethylisothiazolinone or benzoisothiazolinone, alone or in combination. Isothiazolones have polar centers within the molecule, endowing this class of compound with advantages for use in aqueous systems in relation to homogeneous distribution and stabilization through hydration in the overall system.

Particular preference is given to using at least one formaldehyde donor with at least one isothiazolone, in order to provide comprehensive protection against contamination by a microorganism.

Silver, especially in the form of silver ions, silver salts for example, may likewise be employed as a biocide. According to Falbe J., Regnitz M. (1992): Römpp Chemielexikon, 9^{th} edition, vol. 2, PI-S, Stuttgart: Georg Thieme Verlag, silver ions have a strongly antiseptic activity. They exert a blocking effect on the thiol enzymes in microorganisms. Silver ions additionally have strongly fungicidal and bactericidal activities. Silver-containing preparations are therefore being used evermore frequently in the medical/pharmaceutical sectors for wound management, in the form of thin foils or corresponding administration forms for internal and external use as antiseptics and antimycotics. Even in the preparation of drinking water, silver ions are used for sterilization.

Unless explicitly otherwise mentioned, the conditions under which a composition or component thereof is used, studied or employed are room temperature, i.e. a temperature of 20° C. to 25° C., e.g. 21° C. to 24° C., or 22° C. to 23° C., and/or atmospheric pressure, i.e. a pressure of 0.85 bar to 1.1 bar, e.g. 0.9 bar to 1.05 bar, or 0.95 to 1.0 bar.

According to one preferred embodiment of the present invention, the anticorrosion composition has a gel-forming component and the anticorrosion composition solidifies independently after application.

Independent solidification means here that the solidification and therefore the increase in viscosity occur without additional energy input and without any further physical changes before the actual drying process by gel formation.

According to another preferred embodiment of the present invention, the water-based anticorrosion composition comprises at least one of a desired viscosity η, a desired travel distance TD and a desired loss factor tan δ. Here it is the case that

η=47.811 [mPa*s]+4.788 [mPa*s*g⁻¹]*(starting weight of functionalized wax [g])+6.040 [mPa*s*g⁻¹]*(starting weight of surface-active additive [g])+3.895 [mPa*s*g⁻1]*(starting weight of anticorrosion additive [g])+1.389 [mPa*s*g⁻¹]*(starting weight of pH stabilizer [g])+0.798 [mPa*s*g⁻¹]*(starting weight of anticorrosion additive [g])+1.629 [mPa*s*g⁻²]*(starting weight of wax or waxlike substance [g]*starting weight of surface-active additive [g])−0.888 [mPa*s*g⁻²]*(starting weight of surface-active additive [g]*starting weight of pH stabilizer [g])+1.018 [mPa*s*g⁻²]*(starting weight of anticorrosion additive 1 [g]*starting weight of anticorrosion additive 2 [g]);

DT [cm]=17.18 [cm]−2.325 [cm*g⁻¹]*(starting weight of functionalized wax [g])−6.625 [cm*g⁻¹]*(starting weight of a surface-active additive [g])+4.70*[cm*g⁻²]*(starting weight of functionalized wax [g])²−1.625 [cm*g⁻²]*(starting weight of functionalized wax [g]*starting weight of surface-active additive [g]); and

tan δ[ ]=0.5936 [ ]−0.0215 [g⁻¹]*(starting weight of functional wax [g])+0.0353 [g⁻¹]*(starting weight of surface-active additive [g])−0.303 [g⁻¹]*(starting weight of anticorrosion additive 1 [g])+0.0426 [g⁻¹]*(starting weight of pH stabilizer [g])−0.0962 [g⁻²]*(starting weight of functional wax [g]*starting weight of surface-active additive [g])+0.0436*[g⁻²]*(starting weight of functional wax [g]*starting weight of pH stabilizer [g])−0.0529 [g⁻²]*(starting weight of surface-active additive [g])², where η=50 mPa*s±10 mPa*s, DT=25 cm±5 cm and tan δ=0.5±0.2.

The preferred values for the viscosity, the travel distance and the loss factor are as indicated above and may be present independently of one another in the respective value ranges.

Preferably, two of the above conditions are met. Accordingly, the water-based anticorrosion composition comprises (i) a desired viscosity η and a desired travel distance TD, (ii) a desired viscosity η and a desired loss factor tan δ, or (iii) a desired travel distance TD and a desired loss factor tan δ. Here it is likewise the case that η=50 mPa*s±10 mPa*s, DT=25 cm±5 cm and tan δ=0.5±0.2, respectively.

More preferably, all three of the above conditions are met. Accordingly, the water-based anticorrosion composition has a desired viscosity η, a desired travel distance TD and a desired loss factor tan δ. Here it is likewise the case that η=50 mPa*s±10 mPa*s, DT=25 cm±5 cm and tan δ=0.5±0.2, respectively.

According to yet another preferred embodiment of the present invention, the surface-active additive is selected from the group consisting of a nonionic emulsifier, an alkylcarboxylate, an alkylbenzenesulfonate, or an alkyl ether sulfate, the nonionic emulsifier having the general formula R—(O—CH₂—CH₂—)ₓ—OH, where R is an alkyl radical, aryl radical, carboxylic acid radical or a derivative of a carboxylic acid radical, and 3≤x≤50 with x∈ [symbol] .

For the nonionic emulsifier it is preferably the case that 5≤x≤45, 10≤x 40, 15≤x≤35 or 20≤x≤30.

The alkylcarboxylate, alkylbenzenesulfonate or alkyl ether sulfate independently of one another have a molecular weight of 100 g/mol to 1000 g/mol, preferably 150 g/mol to 900 g/mol, 200 g/mol to 800 g/mol, 300 g/mol to 700 g/mol, or 400 g/mol to 600 g/mol.

The alkyl radical may be a substituted or unsubstituted alkyl radical. Illustrative substituents include a methyl group, ethyl group, propyl group, butyl group, hydroxyl group, amino group, thiol group, or a halogen, especially fluorine, chlorine, bromine, iodide.

According to one preferred embodiment of the present invention, the anticorrosion composition comprises 2.0 to 8.0 wt % of the functional wax.

The anticorrosion composition preferably comprises 2.0 to 7.0 wt %, e.g. 3.0 to 6.0 wt %, or 4.0 to 5.0 wt % of the functional wax.

According to another preferred embodiment of the present invention, the organic binder is selected from the group consisting of a hydrocarbon resin, polyurethane acrylate, polyester acrylate, epoxy acrylate, unsaturated and saturated polyesters and other functionalized aqueous dispersions.

According to yet another preferred embodiment of the present invention, the water-based anticorrosion composition comprises 0.1 to 10.0 wt % of the anticorrosion additive.

Preferably 0.2 to 9.0 wt %, e.g. 0.3 to 8.0 wt %, 0.4 to 7.0 wt %, 0.5 to 6.0 wt %, 0.75 to 5.0 wt %, or 1.0 to 2.0 wt %, of the anticorrosion additive are included.

According to one preferred embodiment of the present invention, the anticorrosion additive is selected from the group consisting of an alkali metal sulfonate, alkaline earth metal sulfonate, alkali metal carboxylate, alkaline earth metal carboxylate, condensation product of wax acids and/or fatty acids, saturated and/or unsaturated, with aliphatic amines, alcohols and similar functional groups.

Alkali metal is preferably selected from lithium, sodium or potassium, preferably sodium or potassium. Alkaline earth metal is preferably selected from magnesium or calcium.

The “similar functional groups” comprise, for example, thiols and cyanates, thiocyanates and isothiocyanates.

Aliphatic amines are organic chemical compounds composed primarily of carbon, nitrogen and hydrogen, sometimes contain oxygen, and are not aromatic. The carbon atoms here may be linearly arranged or branched. The aliphatic amines have a molecular weight of in general 100 g/mol to 2000 g/mol, e.g. 200 g/mol to 1000 g/mol.

According to another preferred embodiment of the present invention, the water-based anticorrosion composition comprises 10.0 to 60.0 wt % of fully demineralized water having a conductance of between 0.5 and 5 μS*cm⁻¹ at room temperature.

The water-based anticorrosion composition preferably comprises 20.0 to 45.0 wt %, e.g. 25.0 to 40.0 wt %, or 30.0 to 35.0 wt % of fully demineralized water.

Preference is given to using fully demineralized water having a conductance of between 0.6 and 2 μS*cm⁻¹, e.g. 0.7 to 1 μS*cm⁻¹, or 0.8 to 0.9 μS*cm⁻¹.

According to yet another preferred embodiment of the present invention, the oil is selected from the group consisting of a group I oil, group II oil, group III oil, group IV oil and group V oil. These oils may be used alone or in combination.

A group I oil may be obtained by solvent refining. The group I oils used may be either paraffinic or naphthenic in nature. Group I oils are typically a mixture of different hydrocarbon chains with little or no similarity. Group I oils are therefore readily available and inexpensive.

A group II oil may be obtained by hydrogenation and refining. Illustrative group II oils include mineral motor oils. Group II oils possess adequate to good performance in terms of lubricant properties, such as evaporation tendency, oxidation resistance and flash point, for example.

A group III oil may likewise be obtained by hydrogenation and refining. Group III oils are subjected to the highest stage of mineral oil refining. Over a wide spectrum of properties they afford high performance and also good stability and homogeneity of the molecules.

A group IV oil is a synthetic oil, for example a polyalphaolefin (PAO), and is a common example of a synthetic basic chemical. Group IV oils have a stable chemical composition and unitary molecular chains.

According to one preferred embodiment of the present invention, the water-based anticorrosion composition exhibits two-stage filming.

According to one preferred embodiment of the present invention, an autonomous/independent gelling takes place after a prior loading, and after a further loading with a high shear rate the water-based anticorrosion composition transitions to a fluid state with reduction in viscosity, preferably wherein the high shear rate \dot{γ} is ≥500 s⁻¹.

As a result of the gelling of the anticorrosion composition in a first step, sufficient securement of the anticorrosion composition on, for example, the component is obtained in this step, thereby preventing running at temperatures of 20° C. to 30° C., preferably at room temperature. The second stage is purely physical, by evaporation/vaporization of the water, to give the finished anticorrosion coating.

Hence in a first step the aqueous cavity preservative reversibly develops a gel-like superstructure. For the drying of aqueous systems, exchange of the air masses via the boundary layer is vital. Since the possibilities for this are very limited under prevailing circumstances, as in the case of cavities in vehicles, for example, drying comes to a standstill after the local atmosphere has been saturated. As a result of the ensuing gelling, the material solidifies without any need for an additional thermal process. Only subsequent to the gelling and to the consequent securement of the aqueous cavity preservative on the surface does the material undergo complete filming over time, by an acyclic air mass movement and an associated evaporation of the water.

According to yet a further preferred embodiment of the present invention, the water-based anticorrosion composition exhibits rapid gelling at a shear rate \dot{γ} of 1 s⁻¹ to 10 s⁻¹, with 1 s≤t≤80 s.

According to one preferred embodiment, the water-based anticorrosion composition comprises or consists of: 0.5 to 8.0 wt % of a surface-active additive; 0.5 to 4.0 wt % of a functionalized wax; 5.0 to 30.0 wt % of an organic binder; 0.5 to 10.0 wt % of an anticorrosion additive; 20.0 to 50.0 wt % of fully demineralized water (FDVV); 10.0 to 30.0 wt % of an oil; 2.0 to 8.0 wt % of a wax or waxlike substance; 0.1 to 4.0 wt % of a neutralizing agent; 0.1 to 4.0 wt % of a pH stabilizer; and 0.1 to 1.0 wt % of a biocide, based on 100 wt % of the water-based anticorrosion composition.

### BRIEF DESCRIPTION OF THE DRAWINGS

In the figures:

FIG. 1 shows an illustration of the development of viscosity of an aqueous wax dispersion as a function of the shear rate;

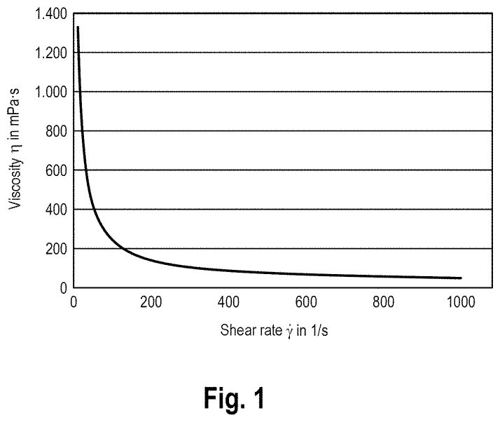

FIG. 2 shows the main effect diagram of the influencing variables on the target variable of viscosity;

FIG. 3 shows the interaction diagram of the predictors on the target variable of viscosity in relation to 2-factor interactional relations;

FIG. 4 shows the main effect diagram of the influencing variables on the target variable of travel distance;

FIG. 5 shows the interaction diagram of the predictors on the target variable of travel distance in relation to 2-factor interactional relations;

FIG. 6 shows viscosity curves as a function of the shear rate \dot{γ} for different emulsifier concentrations;

FIG. 7 shows the development of viscosity and of travel distance of the aqueous cavity preservative as a function of the emulsifier concentration;

FIGS. 8(a)-(b) show a comparison of spray images after pneumatic application for different emulsifier concentrations;

FIG. 9 shows a schematic representation of the development of viscosity for variation of starting weight in the range of ±20 wt %;

FIG. 10 shows the viscosity profile of variant materials as a function of the shear rate without prior mechanical stress;

FIG. 11 shows the viscosity profile of variant materials as a function of the shear rate after mechanical stress;

FIG. 12 shows the development of travel distance before and after mechanical stress for corresponding system formulations after adaptive composition in respect of surface-active components;

FIG. 13 shows the multiple regression of the loss factor tan δ and a valuation of the effects relevant for target variable description;

FIG. 14 shows the development of the structural buildup tan δ and of the relaxation time Δt after prior compressive loading;

FIG. 15 shows leakage amounts against tan δ values after compressive loading;

FIG. 16 shows a view of a standard hollow body for applying an anticorrosion composition;

FIG. 17 shows a coating image of a standard hollow body; and

FIG. 18 shows a coating image of the standard hollow body of FIG. 15 after 480 hours of corrosion exposure.

### EMBODIMENTS

### Example

Forming the basis of the studies is a formulation development process resulting in an aqueous cavity preservative having the properties already described.

The base formulation, which was used to develop the actual formulation, can be seen in table 1. The components employed for the study of the system characteristics are marked within the starting weight limits of ±20 wt %.

TABLE 1
Aqueous cavity preservative (ACP) base formulation

| Item | | | Standard | |
|---|---|---|---|---|
| (wt%) | Component | 80 wt % | (wt %) | 120 wt % |
| 1 | Mineral oil | | 10-40 | |
| 2 | Organic binder | | 0-50 | |
| 3 | Functionalized wax | | 0-5 | |
| 4 | Wax | | 0-15 | |
| 5 | Surface-active additive | | 0-10 | |
| 6 | Anticorrosion additive | | 0-15 | |
| 7 | pH stabilizer | | 0-5 | |
| 8 | FD water | | 20-60 | |
| 9 | Biocide | | 0-2 | |

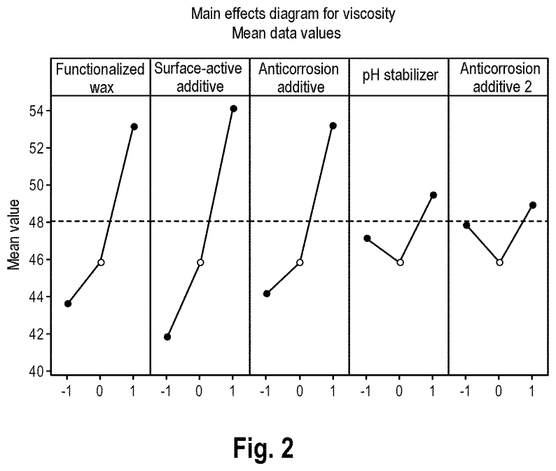

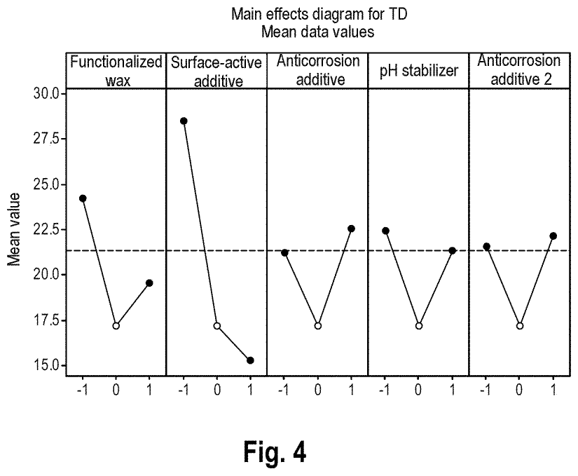

The surface-active additive occupies a substantial share in the formation of properties of the ACP. This relationship is depicted in the main effect diagrams for the respective target variables of viscosity (FIG. 2) and travel distance (FIG. 4). It is determined on the basis of serial experiments with the aid of DoE.

Accordingly, FIG. 2 shows the main effect diagram of the influencing variables on the target variable of viscosity. It is evident that the functionalized wax, the surface-active additive and the anticorrosion additive each exert a strong influence on the viscosity; in the case of the pH stabilizer and other anticorrosion inhibitors, this influence is in the background, but it is still present.

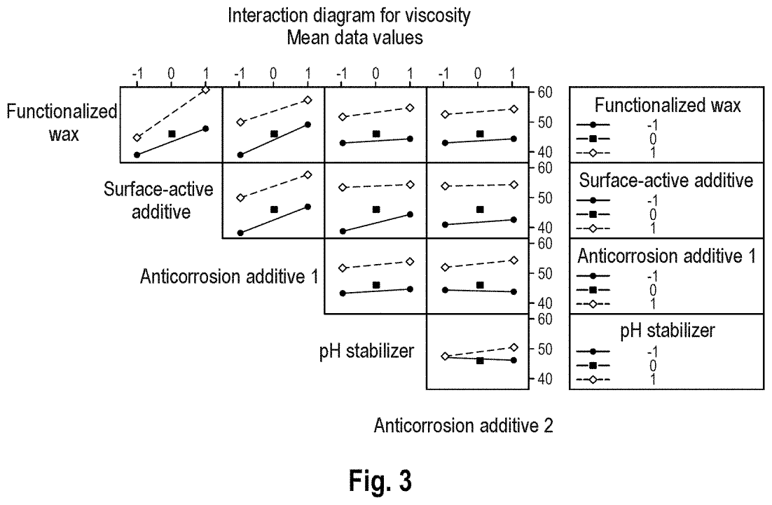

On the basis of the main effect diagram of the influencing variables on the target variable of viscosity, the interactions of the predictors for the target variable of viscosity are now determined under the focus of a 2-factor interactional relationship. The corresponding interaction diagram is found in FIG. 3.

From the component pairings ascertained, it is possible to derive the following interactional relationships, for which, for an altered concentration of one component, the change in concentration of the other components produces a contrary effect:
functionalized wax*surface-active additive;
surface-active additive*pH stabilizer;
anticorrosion additive 1; and
anticorrosion additive 1*pH stabilizer.

The result for the coefficients results from the normalized factor stages. The absolute element carries the unit mPa·s. The coefficients carry the unit mPa·s/g, which shortens in connection with the predictors as starting weight in g to the viscosity [η] in mPa·s. This produces the regression equation of the viscosity according to equation 1:

η [mPa*s]=47.811 [mPa*s]+4.788 [mPa*s*g⁻¹]*(starting weight of functionalized wax [g])+6.040 [mPa*s*g⁻¹]*(starting weight of surface-active additive [g])+3.895 [mPa*s*g⁻¹]*(starting weight of anticorrosion additive 1 [g])+1.389 [mPa*s*g⁻¹]*(starting weight of pH stabilizer [g])+0.798 [mPa*s*g⁻¹]*(starting weight of anticorrosion additive 1 [g])+1.629 [mPa*s*g⁻²]*(starting weight of wax or waxlike substance [g]*starting weight of surface-active additive [g])−0.888 [mPa*s*g⁻²]*(starting weight of surface-active additive [g]*starting weight of pH stabilizer [g])+1.018 [mPa*s*g⁻²]*(starting weight of anticorrosion additive 1 [g]*starting weight of anticorrosion additive 2 [g]). (equation 1)

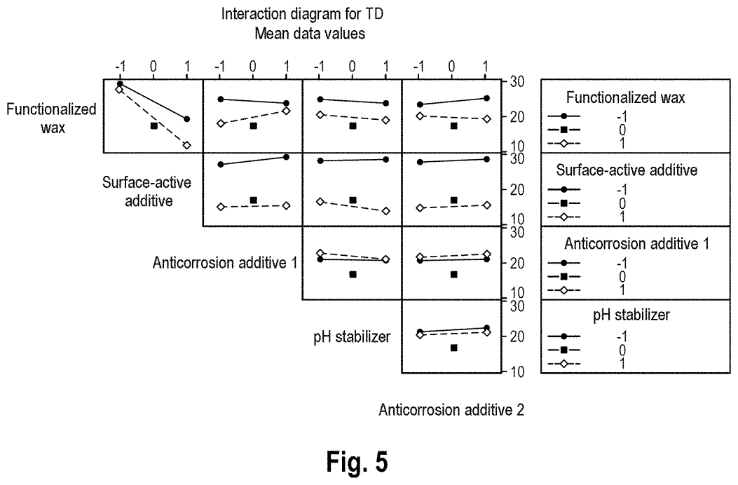

The corresponding approach for the main effect diagram of the influencing variables on the target variable of travel distance (FIG. 4) produces the interaction diagram for travel distance (FIG. 5) in relation to 2-factor interactional relationships. From this diagram, on the basis of an increasing anti-parallelity to one another, the following significant predictor combinations can be isolated:
functionalized wax*surface-active additive; and
functionalized wax*anticorrosion additive 1.

The procedure follows by analogy with the approach for the viscosity. For the units of the TD model, the unit mPa·s is replaced by cm. This results in the regression equation in coded units according to equation 2:

TD=17.18−2.325*(functionalized wax)−6.625*(surface-active additive)+4.70*(functionalized wax)²−1.625*(functionalized wax*surface active additive)

TD=17.18−2.325*[cm*g⁻¹]*(starting weight of functionalized wax [g])−6.625 [cm*g⁻¹]*(starting weight of a surface-active additive [g])+4.70*[cm*g⁻²]*(starting weight of functionalized wax [g])²−1.625 [cm*g⁻²]*(starting weight of functionalized wax [g])². [equation 2]

From the results of the target variable-specific system modeling it is then possible to derive a number of optimized and/or adapted compositions, which are set out in table 2.

TABLE 2
Model-based forecast target variables through
optimized starting weight amounts of the system components

| | Target variable | | | |
|---|---|---|---|---|
| | Viscosity in mPa · s | | Travel distance in cm | |
| Predictor | optimized | forecast | optimized | forecast |
| Functional wax | 0¹ | −1 | 1 | 1 |
| Surface-active | 0¹ | 1 | −0.78 | −1 |
| additive | | | | |
| Anticorrosion | 0¹ | 1 | 0¹ | 0¹ |
| additive 1 | | | | |
| pH stabilizer | 1 | 1 | 0¹ | 0¹ |
| Anticorrosion | 1 | −1 | 0¹ | 0¹ |
| additive 2 | | | | |

¹Predictors irrelevant for describing the target variables are treated in the same way as for the base formulation.

The respective results are determined in analogy to the techniques to date. An overview of the measured target variables for the estimates mandated in table 2 is shown by table 3. The forecast interval of 95% is based on the model calculations and hence on the starting weight mandates. The fields with gray shading mark the resultant measurement value of the control estimates. These are for comparison with the mandated targeted variable. The characteristic variables of the estimates are a very good match between intended value and actual value, and are situated within the specific confidence range of the respective target variable.

TABLE 3
summary of the results in comparison
to the intended value of the model output

| | Viscosity in mPa · s | | Travel distance in cm | |
|---|---|---|---|---|
| Characteristic variable | optimized | forecast | optimized | forecast |
| Target variable | 5.0 ± 6.0 ¹ | 50.0 | 26 ± 9.4 ¹ | 27.8 |
| Estimate for viscosity | 46.8 | 51 | 13 ² | 17 ³ |
| in mPa · s | | | | |
| Estimate for travel | 44.5 | 42.9 | 29 ⁴ | 26 ⁵ |
| distance in cm | | | | |
| Estimate for tan δ | 58.9 | 35.5 | 19 ⁶ | 25 ⁷ |

¹ Target variable mandate according to the model and the forecast interval of Fl = 95%.
² r.H.: 46.5%; T: 26.7° C.
³ r.H.: 45.6%; T: 26.6° C.
⁴ r.H.: 45.9%; T. 26.5° C.
⁵ r.H.: 46.4%; T. 26.2° C.
⁶ r.H.: 52.1%; T: 25.7° C.
⁷ r.H.: 53%; T: 26.6° C .

It becomes apparent that the respective characteristic variables must only be optimized independently of one another. A further result apparent from the studies is the difficulty of optimizing the different target variables at the same time.

With the aid of the models and of the resultant equations 1 and 2, combinations can then be completed which correspond to the common optimum in relation to the target-value corridor of the characteristic variables.

The optimized viscosity, then, leads to a markedly reduced travel distance below the permissible limiting value. In the case of the ideally set travel distance, the viscosity is still within the specified range, but the structural buildup slips away. The material optimized in this way, accordingly, is more viscous and less gel-like.

With the aid of the models generated it is possible to calculate all target variables by mandates for the component starting weights and to determine a target corridor for all relevant system properties. This is possible purely arithmetically, without long serial experiments having to be carried out on the principle of trial and error, which consumes resources of all kinds. On the basis of this approach, it is then possible just to select the experiments which are purposive, from the calculation, and to verify them in terms of their compliance.

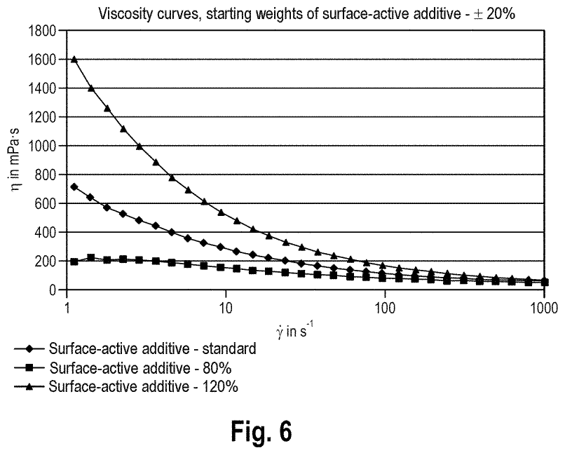

Translated into practice, for a starting weight of surface-active additive that varies by ±20 wt %, the viscosity curves summarized in FIG. 6 come about as a function of the shear rate for different concentrations of emulsifier. The shear rate range chosen for the study in this case was from \dot{γ}=1 s⁻¹ to \dot{γ}=1000 s⁻¹. This study window embraces the low-shear range (\dot{γ} 1 s⁻¹≤\dot{γ}≤500 s⁻¹), in which there is gravitational flow (\dot{γ} 1 s⁻¹≤\dot{γ}≤10 s⁻¹), and also the high-shear range (\dot{γ}>500 s⁻¹, especially 500 s⁻¹<\dot{γ}≤1000 s⁻¹), which reflects the shearing load during spray application. The material under study was circulated beforehand through a mini-circuit line and so subjected to mechanical loading within the periphery before the applicator.

In the course of the cyclical conveying of the sample material, it interacts with the internal walls of the unit. Contained herein are the central influencing variables for describing the rheology. The definition of the viscosity η can be translated accordingly to the circuit line. The pressure p needed for the circulation of the material is defined as F/A. In purely physical terms, therefore, it corresponds to the shear stress T. The shear rate \dot{γ} is to be understood by way of a temporarily changing deformation. The system here is deflected by the path length S. There is therefore an analog to the velocity v. This is provided by the opening at the end of the line. By means of the law of Hagen and Poiseuille, the viscosity can be calculated. For this purpose it is necessary to assume a parabolic velocity profile, with the maximum change in velocity at the point of greatest slope. The volume flow rate \dot{V}, and also the shear rate \dot{γ} which acts on the dispersion during circulation, must be known.

$$\dot{V} = \frac{dV}{dt} = \frac{π \cdot {r}^{4}}{8 \cdot η} \cdot \frac{Δ p}{I} \qquad Equation 3$$

This can be rewritten for the viscosity η as follows:

$$η = \frac{π \cdot {r}^{4}}{8 \cdot \dot{V}} \cdot \frac{Δ p}{I} \qquad Equation 4$$

The shear rate \dot{γ} is computed accordingly as follows:

$$\dot{γ} = \frac{4 \cdot \dot{V}}{π \cdot {r}^{3}} \qquad Equation 5$$

On the basis of the instrumental data for the mini-circuit line (CL) with a:
Preset pressure of p=120 bar, a radius of r=1.0·10⁻³ m, and a volume flow rate of \dot{V}=10·10⁻⁶ m/s, therefore, the resulting shear rate is \dot{γ}≈12 500 s⁻¹.

The system reacts correspondingly and becomes lower in viscosity. Viscosity decreases of up to 50% relative to the standard measurement at shear rates of \dot{γ}=1000 s⁻¹ from the resting state are typical of the system here. By looking at the viscosity in the low-shear range and also in the high-shear range, the relaxation capacity and the further drop in viscosity with increasing shear rate are then ascertained.

The instrument used is preferably a Rheolab QC (Anton Paar, Austria) with associated cylinder measurement system, according to manufacturer details. The shear rate is kept constant for preliminary shearing at \dot{γ}=1000 s⁻¹. The central measuring section is resolved with a logarithmic shear rate ramp of \dot{γ}=0.01 s⁻¹ to 1000 s⁻¹ in order to determine the viscosity values in the low-shear range and also in the high-shear range.

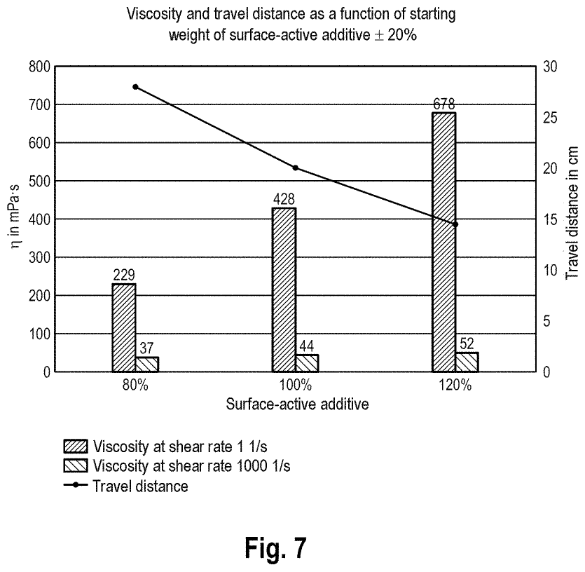

Looking at FIG. 6, a variation is apparent in the three estimates for a shear rate of \dot{γ}=1000 s⁻¹. This corresponds to the representation of the influence of the surface-active additive in FIG. 2. Relative to the travel distance (FIG. 4), the same picture arises. FIG. 7 summarizes the two characteristic variables of viscosity and travel distance of the ACP as a function of the emulsifier concentration, in one diagram.

The increase in viscosity on increased addition of surface-active additive, which is known from the modeling, is observed both in the high-shear range and in the low-shear range. The effect becomes marked in particular toward lower shear rates. The relatively steep drop in the travel distances is therefore explained, since the shear forces which act during this measurement are to be assumed, in the range 0.5 s⁻¹≤\dot{γ}≤5 s⁻¹.

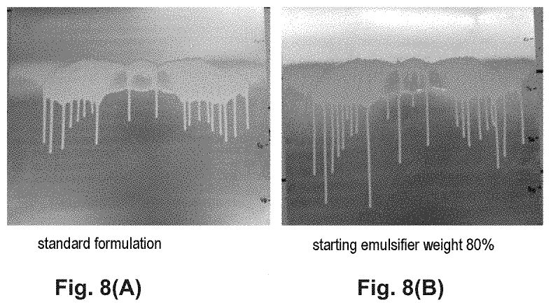

Transposed to practice, the material is applied to flat metal sheets and the running characteristics from the flat sheets set up vertically are determined over a period of t=60 s. In this regard, FIG. 8 compares the spray images after pneumatic application for different concentrations of emulsifier, based on table 6, with a surface-active additive concentration reduced by 20%.

From the running images, the effect of the emulsifier in relation to the running behavior is clearly apparent. This method has been trialed for an estimation of the line suitability in general, particularly on the customer side, and is used for quality evaluation. In this case as well, the difference in flow behavior is clearly evident from a comparison of a batch with reduced concentration of the surface-active additive relative to the standard.

Based on these findings, therefore, it is possible to develop and/or formulate customer-specific or application-optimized materials through variation in the surface-active substances in the range of ±20 wt %, and also through targeted substitution of the property-determining components by functionally analogous substances or preparations.

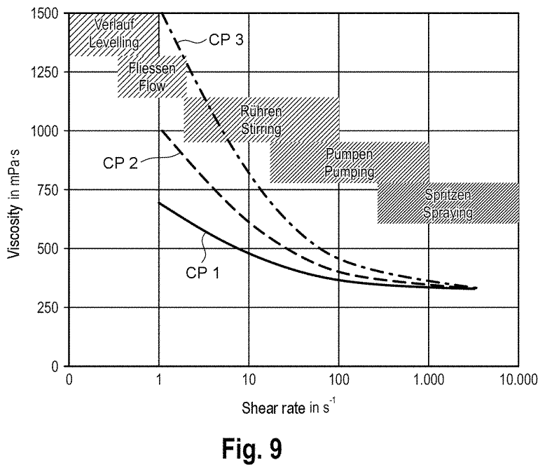

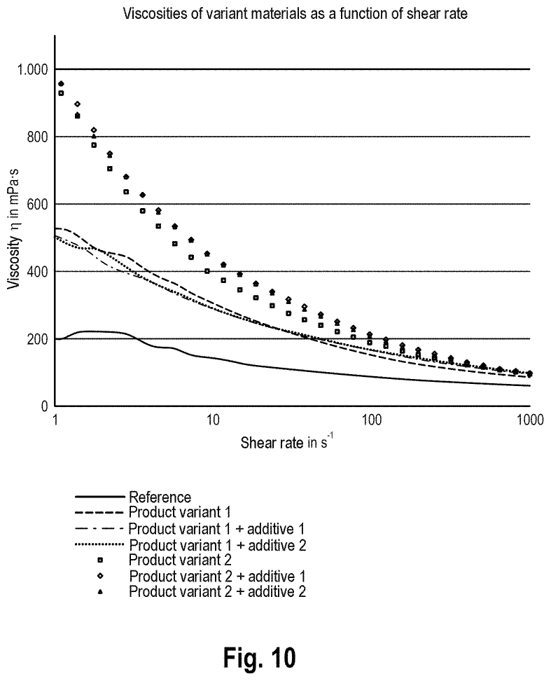

Represented schematically in FIG. 9 is the development of the viscosity over the respective degree of mechanical stress, translated into the respective process steps over the shear rate in the range \dot{γ}=1 s⁻¹ to 1000 s⁻¹, for three materials with the same basis but with varying starting raw-material weight of one component of ±20% (see also FIG. 10). Based on table 4 with a 20%-reduced concentration of surface-active additive (product variant 1) and of the anticorrosion additive (product variant 2).

As a general rule, the shear rate is mandated and the maintenance of the shear stress is captured by measurement. Hence FIG. 9 shows the schematic representation of the development of viscosity on variation of starting weight in the range of ±20 wt %. It is evident that as the shear rate goes up, there is a significant drop in the viscosity, with the final measurement values, independently of the resting viscosity, converging essentially at a final value. This ensures a tidy and good profile, even in complex constructions. Subsequently, the structures formerly destroyed by shearing are formed again, and again generate gels or raise the viscosity to an extent such that the material comes to a standstill. All of the effects described so far are purely physical and can be repeated as often as desired, since they are reversible.

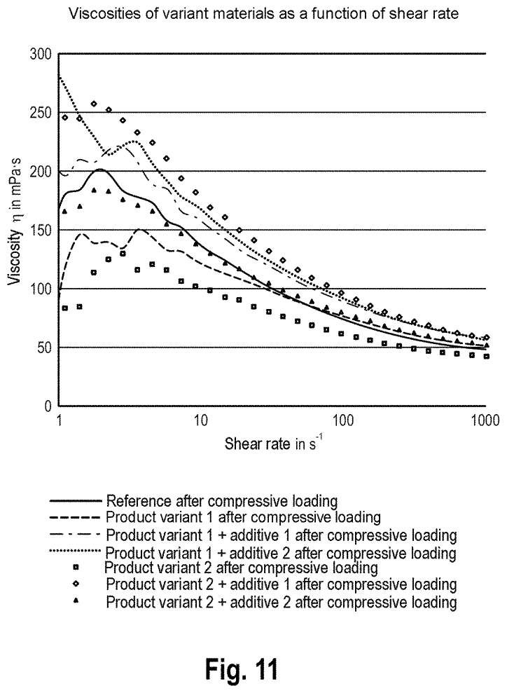

This behavior is also achieved on the development side, as evident from FIGS. 10 and 11. Summarized here are direct adaptations of the viscosity via corresponding mixtures based on a modification to ratios of the surface-active system components. In spite of high resting viscosities in the shear rate range of γ=1 s⁻¹, the leveling effect is clearly apparent, with increasing shear rate toward low viscosities. This viscosity reduction may amount to up to one power of 10.

In this regard, FIG. 10 shows the viscosity profile of variant materials as a function of the shear rate without prior mechanical stress. FIG. 11 shows the graphs of the same materials after mechanical loading has taken place on the system. In this case a further property of the system is illustrated. As a result of the compressive loading, there is a shift in equilibrium in the solubilities of the stabilizing, surface-active compounds, owing to the supply of energy in the form of friction as a result of circulation in the line. As a result, there is again a drop in viscosity. Depending on formulation and adaptation, this fall may amount to less than ⅙ of the resting viscosity or half of the high-shear viscosity at \dot{γ}=1000 s⁻¹. This effect can therefore likewise be controlled again by way of the amounts of surface-active substances within the system. The reversibility already described is likewise retained.

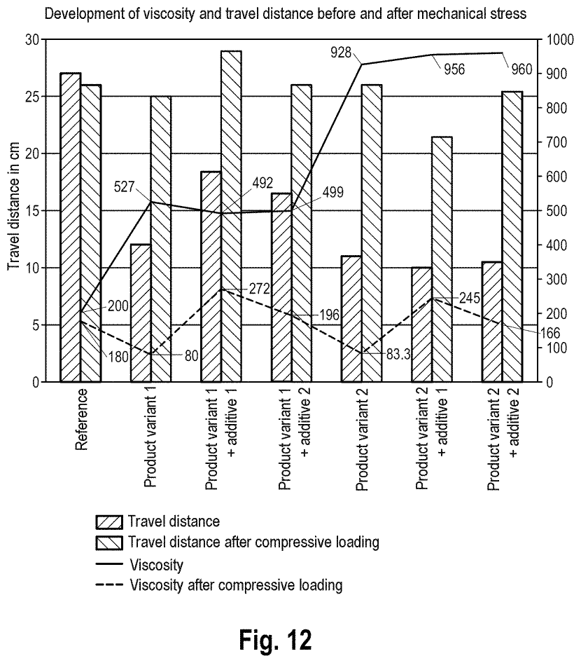

Transposition to the travel distances can be seen from FIG. 12. The relationship of the resultant travel distances from the resting viscosity (\dot{γ}=1 s⁻¹) is evident from the development shown in travel distances before and after mechanical stressing of corresponding system formulations after adaptive composition in respect of surface-active components.

The influence of a prior mechanical loading is marked. This influence additionally supports the good profile and a virtually complete penetration immediately after application has taken place.

As a result of the development of a multiplicity of interactions, the system of the ACP is notable for a viscoelastic behavior within the limits of Hook's law and Newton's law. This can be determined metrologically with the aid of oscillating measurement setups.

The structural strength of such a material is defined via the gel character. The latter is coupled directly to the storage modulus G′. It is a measure of the deformation energy stored reversibly in the sample material. It is also designated the real part of a sample. This energy is accommodated by the system during the duration of the shearing load, and stored. When the load on the sample is removed, it is available again in its entirety for relaxation and renewed structural buildup of the material. It constitutes an absolute value for the elastic, solid body-determined part of the sample characteristics.

The storage modulus G′ is defined in the form of a cosine function. It can be calculated via the phase shift as a purely elastic component of a viscoelastic fluid

(Gerth, C. (1980): Rheometrie [Rheometry], in: Bartholomé E., Biekert, E., Hellmann, H., Ley, H., Weigert, W. M., Weise, E., Ullmanns Enzyklopädie der technischen Chemie 4th edition vol. 5 Analysen- and Messverfahren, Weinheim: Verlag Chemie, pp. 755-777; Mezger T. (2010): Das Rheologiehandbuch [The Rheology Handbook], 3^{rd} edition, Hannover: Vincentz Network; Rose, C. (1999): Stabilitätsbeurteilung von O/W-Cremes auf Basis der wasserhaltigen hydrophilen Salbe DAB 1996 [Stability assessment of O/W creams on the basis of the water-containing hydrophilic ointment of DAB (German Pharmacopeia) 1996, Dissertation, Technical University of Carola-Wilhelmina at Braunschweig):

$${G}^{′} = \frac{{τ}_{A}}{{γ}_{A}} \cdot cos δ \qquad Equation 6$$

The loss modulus G″, also called imaginary part, denotes the purely viscous component of a material. It describes the deformation energy which is lost irreversibly, in the form of internal friction and rearrangement reactions. The loss modulus may be expressed by a sine function (Gerth, C. (1980): Rheometrie [Rheometry], in: Bartholomé E., Biekert, E., Hellmann, H., Ley, H., Weigert, W. M., Weise, E., Ullmanns Enzyklopädie der technischen Chemie 4th edition vol. 5 Analysen-und Messverfahren, Weinheim: Verlag Chemie, pp. 755-777; Mezger T. (2010): Das Rheologiehandbuch [The Rheology Handbook], 3^{rd} edition, Hannover: Vincentz Network; Rose, C. (1999): Stabilitätsbeurteilung von O/W-Cremes auf Basis der wasserhaltigen hydrophilen Salbe DAB 1996 [Stability assessment of O/W creams on the basis of the water-containing hydrophilic ointment of DAB (German Pharmacopeia) 1996, Dissertation, Technical University of Carola-Wilhelmina at Braunschweig):

$${G}^{″} = \frac{{τ}_{A}}{{γ}_{A}} \cdot sin δ \qquad Equation 7$$

With the aid of these two moduli, the so-called loss factor tan δ is computed as follows (Gerth, C. (1980) Rheometrie [Rheometry], in: Bartholomé E., Biekert, E., Hellmann, H., Ley, H., Weigert, W. M., Weise, E., Ullmanns Enzyklopädie der technischen Chemie 4th edition vol. 5 Analysen-und Messverfahren, Weinheim: Verlag Chemie, pp. 755-777; Mezger T. (2010): Das Rheologiehandbuch [The Rheology Handbook], 3rd edition, Hannover: Vincentz Network):

$$tan δ = \frac{{G}^{″}}{{G}^{′}} \qquad Equation 8$$

In summary:
tan δ=∞, when G″>>and lim_{G′}0: ideal viscous behavior
tan δ>1, when G″>G′: primary behavior corresponding to a liquid
tan δ=1, when G′=G″: sol/gel transition point
tan δ<1, when G′>G″: primary behavior corresponding to a gel/solid
tan δ=0, when G′>>and lim_{G″}0: ideal elastic behavior.

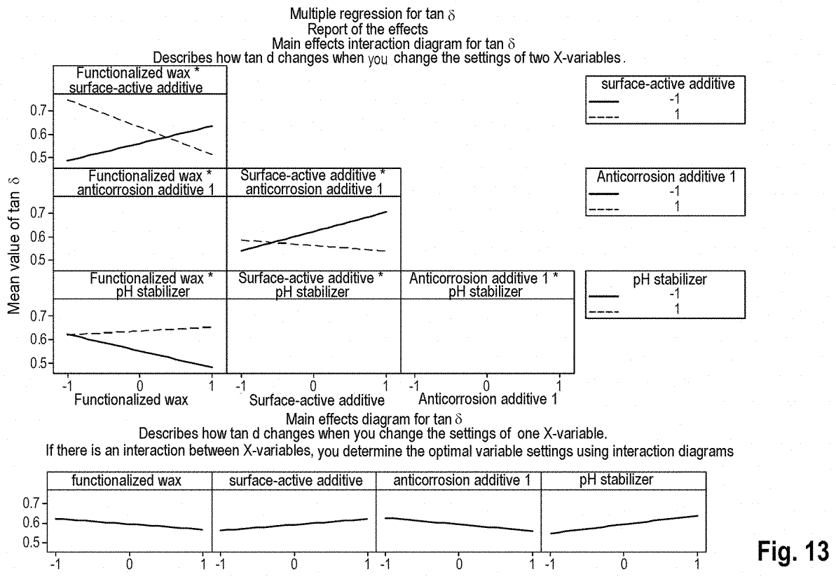

With the aid of the loss factor it is possible, for example, to derive curing processes for reactive systems. For the loss factor as well, with the aid of statistical design of experiment, modeling was undertaken. The loss factor tan δ is influenced by three essential variations and factor combinations. This can be taken from FIG. 13—the multiple regression of the loss factor tan δ and evaluation of the effects relevant for the description of target variables are shown.

It is apparent that the critical influence on the target variable is based primarily on 2-factor interactions (equation 9). Only the pH stabilizer displays an effect as an individual component.

The situation is therefore as follows:

tan δ=0.5936−0.0215 [g⁻¹]*(starting weight of functional wax [g])+0.0353 [g⁻¹]*(starting weight of surface-active additive [g])−0.303 [g⁻¹]*(starting weight of anticorrosion additive [g])+0.0426 [g⁻¹]*(starting weight of pH stabilizer [g])−0.0962 [g⁻²]*(starting weight of functional wax [g]*starting weight of surface-active additive [g])+0.0436*[g⁻²]*(starting weight of functional wax [g]*starting weight of pH stabilizer [g])−0.0529 [g⁻²]*(starting weight of surface-active additive [g])². (equation 9)

tan δ=0.5936−0.0215*(functional wax)+0.0353*(surface-active additive)−0.0303*(anticorrosion additive)+0.0426*(pH stabilizer)−0.0962*(functional wax*surface-active additive)+0.0436*(functional wax*pH stabilizer)−0.0529*(surface-active additive*anticorrosion additive)

Taking account of the model qualities calculated, all of the target variables are situated within the required specification or stipulated boundary ranges (table 4).

TABLE 4
Representation of model quality via comparison of the resultant
fluctuation margins in comparison to the product specification

| | | | Fluctuation | Fluctuation |
|---|---|---|---|---|
| | | | margin | margin, |
| | Intended | R-Qd. | based | product |
| Target variable | value | in % | on model | specification |
| Viscosity in mPa · s | 50 | 93 | ±3.6 | ±10 |
| Travel distance in cm | 26 | 75 | ±6.6 | ±4 |
| tan δ | 0.5 | 60 | ±0.2 | — |

tan δ = 0.5936 − 0.0215 * (functional wax) + 0.0353 * (surface-active additive) − 0.0303 * (anticorrosion additive) + 0.0426 * (pH stabilizer) − 0.0962 * (functional wax * surface-active additive) + 0.0436 * (functional wax * pH stabilizer) − 0.0529 * (surface-active additive * anti-corrosion additive)

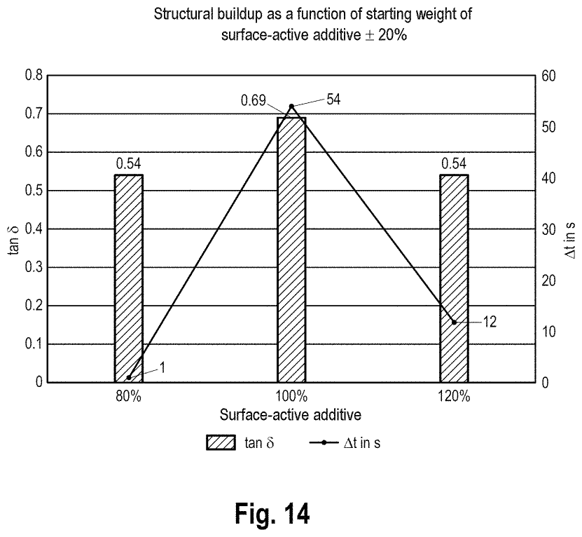

In the present system of the ACP, it is possible, when applying the model, to ascertain the influence of the emulsifier concentration more clearly on the property of the structural buildup. Hence FIG. 14 shows the development of the structural buildup tan δ and of the relaxation time Δt after prior compressive loading. The time span Δt before the sol-gel transition is reached provides information on how long the material retains a clear-liquid form, before it reverts to a gel-like and therefore more elastic state. In the case of penetration, this may be greatly important.

As well as the duration before the structure is built up, in order to ensure the penetration, it is also necessary to secure the material in the regions where protection is to take place. With the complex geometries this is critical, since in light of the limited volume, water vapor saturation comes about very rapidly and hence physical drying is no longer possible, before the actual drying begins. A controllable structural buildup is therefore an advantage.

Using the example of different variant materials (table 5), the drip leakage behavior is determined and compared. For this purpose, 15 mL of material are applied into a test sill with a length of 50 cm. After a resting phase of 7 h, the component is rotated once about the longitudinal axis and placed at an angle of [symbol] 15°. The amount of material leaking out is then collected and weighed.

TABLE 5
Results of leak test

| | η in mPa · s after RL | | | TD flat | | | Leakage |
|---|---|---|---|---|---|---|---|
| | Shear rate | Shear rate | TD | sheet | Δt | | amount |
| Mixture | [symbol] 1 s⁻¹ | [symbol] 1000 s⁻¹ | in cm | in cm | in s | tan δ | in g |
| Standard | 428 | 44 | 21 | 15 | 150 | 0.7 | 12.0 |
| laboratory | | | | | | | |
| mixture | | | | | | | |
| 13 | 219 | 35 | 25 | 28 | 10 | 0.6 | 8.6 |
| 14 | 158 | 34 | 30 | 25 | 25 | 0.8 | 13.6 |
| 26 | 229 | 37 | 28 | 28 | 1 | 0.5 | 8.5 |

The material, with a starting weight of emulsifier reduced by 20 wt %, exhibits the lowest leakage amount of the mixtures investigated, in comparison to the standard formulation (table 5, mixture 26). Although the reference features the shortest run lengths after application, the leakage amount is greater. Mixture 14 does have good running behavior after application, but scores the worst in terms of the leakage amount. The amounts leaked do not correlate with the running behavior of the travel distances. However, the material leaking in drips is proportional to the tan δ and hence to the storage modulus (equation. Given correct formulation, the loss modulus of a material having a tan δ of 0.54 is still sufficient to ensure the requisite penetration directly after application, during coalescence. The reason for this lies in the fact of the thixotropic rheology profile for the system of the ACP. One particular feature of the emulsifier is its capacity to gel via an aging process. This gel is based purely on physical interactions and generates a long-term stability under standard conditions (T=20° C.; r.H. 60%) of at least more than a year. The structural buildup described is sufficient to cause the material to attain resting viscosities of 1000 mPa·s. Unique in this context is the property of leveling of this effect by sufficiently high shearing forces in the range of shear rates \dot{γ}≥1000 s⁻¹. As a result, the material undergoes liquefaction again to an extent not only that it is possible to overcome corresponding distances from the injection hole to difficult-to-reach constructions within the bodywork geometry, but also that sufficient penetration is ensured into extremely narrow folds and gaps. The elastic component in the material produces a further structural buildup after a certain time. The material gels again and accordingly, still in the liquid form, is secured in the component. Hence it is possible to unite the body of the chassis in the assembly without having to employ thermally initiated processes. The gel strength is sufficiently high to withstand rotations, tipping or pivoting of the body, without subsequent leakage. As a result, clean and safe working is possible. The actual drying, likewise ensuing after application, follows. However, it constitutes a long-term process, depending on the climatic conditions. The gelling effect, with exclusion of the drying, can be carried out reversibly as often as desired for the pure liquid material, within the process parameters and pressures up to p=120 bar.

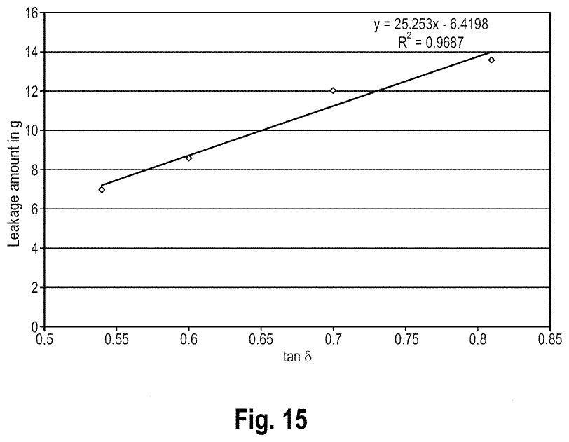

FIG. 15 shows the relationship between the structural strength via the loss factor tan δ and the leakage amount after compressive loading. A linear relationship of the two variables can be seen (FIG. 15). This is apparent with a coefficient of determination of 0.969.

From the studies it is possible to model the target variables and the material properties directly by way of the raw material starting weights. This provides customer-specific formulation of materials in accordance with the application requirements and the component geometries. As a result, optimum coating is possible via quantity adaptation and material reduction, corresponding to a principle of sustainability and to resource preservation. With knowledge of the influence exerted by the respective raw materials, it is then possible to draw up further formulations as well, as a function of the desired properties, and so to improve and facilitate the development work.

Accordingly, table 6 shows an example formulation for an ACP according to the present invention

TABLE 6
Example formulation of an ACP

| Item | Component | CAS Number | Standard (wt %) |
|---|---|---|---|
| 1 | Mineral oil, group I | 64742-54-7 | 26.0% |
| 2 | HC resin, phenol-modified | 71302-91-5 | 7.0% |
| 3 | Paraffin wax | 8002-74-2 | 5.1% |
| 4 | Acid-functionalized wax - Oxidized | 64743-00-6 | 5.0% |
| | petroleum wax | | |
| 5 | Fatty acid-based, nonionic | 9002-92-0 | 2.4% |
| | emulsifier | | |
| 6 | Petroleum-based sulfonic acids | 61789-86-4 | 4.6% |
| | and their calcium salts | | |
| 7 | Styrene-acrylate dispersion, SC | 25085-34-1 | 17.0% |
| | 50% | | |
| 8 | Neutralizing agent | 100-37-8 | 0.5% |
| 9 | pH stabilizer, 30% ammonia | 7664-41-7 | 0.1% |
| 10 | FD water | 7732-18-5 | 32.1% |
| 11 | Biocide | 2634-33-5 | 0.2% |

The present ACP possesses a viscosity of η=57 mPa·s (50 mPa·s±10 mPa·s), measured at 23° C. using the Rheolab QC (Anton Paar, Austria) with rotation, a travel distance of TD=20 cm (25 cm±5 cm) and tan δ=0.6 (0.5±0.2) measured at 23° C., with a circular frequency ω=10 rad/s and a deformation of γ=5% with the MRC 302 (Anton Paar, Austria) with oscillation.

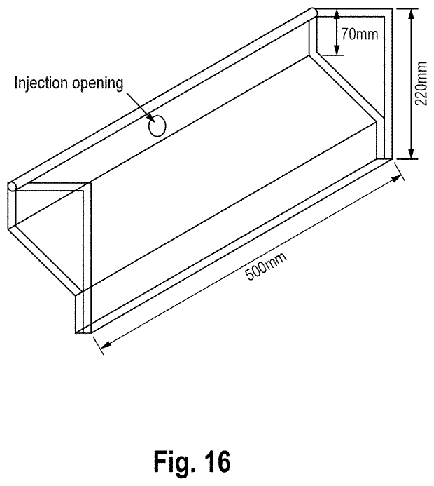

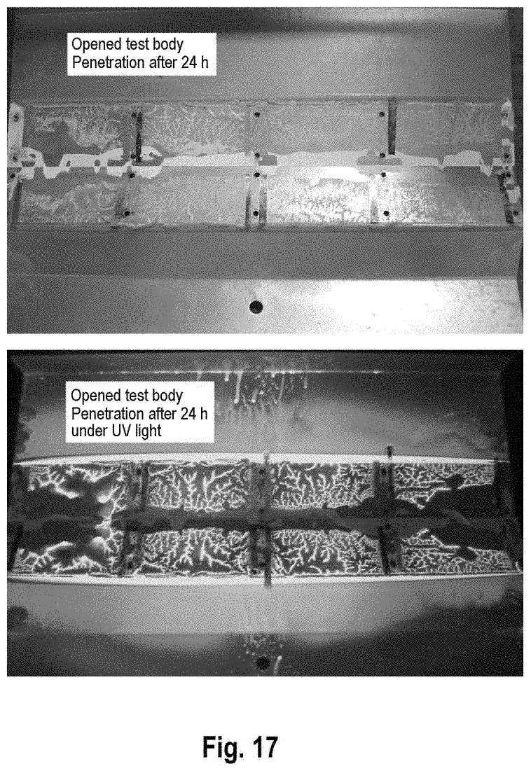

The ACP is introduced in a user-specific way, using a multiple nozzle, via the centrally sited injection hole, into a standard hollow body, or a reduced “test sill” (FIG. 16) with integrated flange (metal sheet doubling) and a gap dimension of 100 μm. The application parameters are set at V=15 mL and an atomizer (air) pressure of 5.5 bar and a material pressure of 100 bar to 120 bar. Via the development of the spray cone in the interior of the hollow body, there is extensive wetting, which subsequently goes over into running and hence reaches the regions where preservation is to take place. By way of wetting effects and capillary effects, the ACP spreads, coalesces, covering corners and edges as it does so, and ultimately penetrating into folds and gaps. The corresponding coating image of a standard hollow body can be seen in FIG. 17. In this case the ACP was introduced as described and opened after standing storage for 24 h. Here, the ACP penetrates into the entire flange region.

The corrosion protection properties of the ACP take place in accordance with DIN EN ISO 9227 on different substrates. These correspond as standard to the materials used in automobile construction. The steel substrate used is the Q-Panel R36 from Q-Lab Deutschland GmbH, In den Hallen 30, D-66115 Saarbrücken, Germany, with dimensions of 76 mm×152 mm and a thickness d=0.81 mm. In comparison, the galvanized substrate GARDOBOND® HDG 6 (HDG: Hot dip galvanized steel panel) from Chemetall GmbH corporate communications, Trakehner Str. 3, 60487 Frankfurt am Main is used, with the dimensions 105 mm×190 mm and a thickness d=0.81 mm.

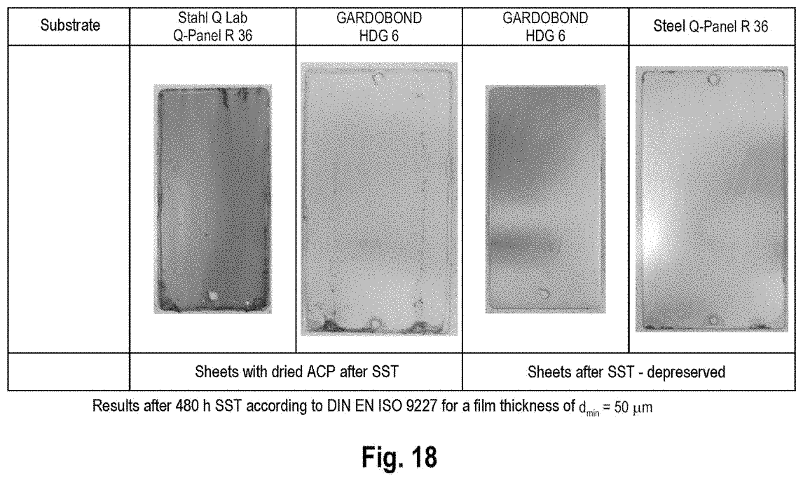

Application takes place pneumatically by means of a cup-fed gun, e.g. SataJet®, at an atomizer pressure of around 3.5 bar, with a nozzle opening of 0.8 mm to 1.2 mm. The target wet film thickness is at least 90 μm to 100 μm, corresponding to a dry film thickness of at least 50 μm. The film thus applied is dried for 72 h and then subjected to corrosion testing (salt spray test—SST). For at least 480 h the coating exhibits no corrosion in a corrosive atmosphere (FIG. 18).

What is claimed is:

1. A water-based anticorrosion composition, which is a cavity preservative composition, a composition for underbody protective coating, a composition for permanent storage and transit protective coating, or a composition for temporary storage and transit protective coating, wherein the anticorrosion composition is intended for the corrosion control of a component, more particularly an automotive part, characterized in that the anticorrosion composition can be applied cold, is reversibly gelling and physically drying, even in thick layers, and is rheologically controllable, adjustable according to utility.

2. A water-based anticorrosion composition, optionally as claimed in claim 1, comprising or consisting of:
0.1 to 10.0 wt % of a surface-active additive,
0.0 to 5.0 wt % of a functionalized wax,
1.0 to 40.0 wt % of an organic binder,
0.1 to 15.0 wt % of an anticorrosion additive,
10.0 to 50.0 wt % of fully demineralized water (FDVV),
1.0 to 40.0 wt % of an oil,
1.0 to 20.0 wt % of a wax or waxlike substance,
0.0 to 5.0 wt % of a neutralizing agent,
0.0 to 5.0 wt % of a pH stabilizer, and
0.0 to 2.0 wt % of a biocide, based on 100 wt % of the water-based anticorrosion composition.

3. The water-based anticorrosion composition as claimed in claim 2, wherein the anticorrosion composition comprises a gel-forming component and the anticorrosion composition after application solidifies independently (without additional energy input and without any further physical changes before the actual drying process by gelling).

4. The water-based anticorrosion composition as claimed in claim 2, comprising at least one of a desired viscosity η, a desired travel distance LS and a desired loss factor tan δ, with
η=47.811 [mPa*s]+4.788 [mPa*s*g⁻¹]*(starting weight of functionalized wax [g])+6.040 [mPa*s*g⁻¹]*(starting weight of surface-active additive [g])+3.895 [mPa*s*g⁻1]*(starting weight of anticorrosion additive 1 [g])+1.389 [mPa*s*g⁻¹]*(starting weight of pH stabilizer [g])+0.798 [mPa*s*g⁻¹]*(starting weight of anticorrosion additive 1 [g])+1.629 [mPa*s*g⁻²]*(starting weight of wax or waxlike substance [g]*starting weight of surface-active additive [g])−0.888 [mPa*s*g⁻²]*(starting weight of surface-active additive [g]*starting weight of pH stabilizer [g])+1.018 [mPa*s*g⁻²]*(starting weight of anticorrosion additive 1 [g]*starting weight of anticorrosion additive 2 [g]);
DT [cm]=17.18 [cm]−2.325 [cm*g⁻¹]*(starting weight of functionalized wax [g])−6.625 [cm*g⁻¹]*(starting weight of a surface-active additive [g])+4.70*[cm*g⁻²]*(starting weight of functionalized wax [g])²−1.625 [cm*g⁻²]*(starting weight of functionalized wax [g]*starting weight of surface-active additive [g]); and
tan δ[ ]=0.5936 [ ]−0.0215 [g⁻¹]*(starting weight of functional wax [g])+0.0353 [g⁻¹]*(starting weight of surface-active additive [g])−0.303 [g⁻¹]*(starting weight of anticorrosion additive [g])+0.0426 [g⁻¹]*(starting weight of pH stabilizer [g])−0.0962 [g⁻²]*(starting weight of functional wax [g]*starting weight of surface-active additive [g])+0.0436*[g⁻²]*(starting weight of functional wax [g]*starting weight of pH stabilizer [g])−0.0529 [g⁻²]*(starting weight of surface-active additive [g]*starting weight of surface-active additive [g]), where η=50 mPa*s±10 mPa*s, DT=25 cm±5 cm and tan δ=0.5±0.2.

5. The water-based anticorrosion composition as claimed claim 2, wherein the surface-active additive is selected from the group consisting of a nonionic emulsifier, an alkylcarboxylate, an alkylbenzenesulfonate, or an alkyl ether sulfate, the nonionic emulsifier having the general formula R—(O—CH₂—CH₂—)ₓ—OH, where R is an alkyl radical, aryl radical, carboxylic acid radical or a derivative of a carboxylic acid radical, and 3≤x≤50 with x∈ [symbol] .

6. The water-based anticorrosion composition as claimed in claim 2, wherein the anticorrosion composition comprises 2.0 to 8.0 wt % of the functional wax.

7. The water-based anticorrosion composition as claimed in claim 2, wherein the neutralizing agent is an amine.

8. The water-based anticorrosion composition as claimed in claim 2, wherein the organic binder is selected from the group consisting of a hydrocarbon resin, polyurethane acrylate, polyester acrylate, epoxy acrylate, unsaturated and saturated polyesters and other functionalized aqueous dispersions.

9. The water-based anticorrosion composition as claimed in claim 2, wherein the anticorrosion composition comprises 0.1 to 10.0 wt % of the anticorrosion additive.

10. The water-based anticorrosion composition as claimed in claim 2, wherein the anticorrosion additive is selected from the group consisting of an alkali metal sulfonate, alkaline earth metal sulfonate, alkali metal carboxylate, alkaline earth metal carboxylate, condensation product of wax acids and/or fatty acids, saturated and/or unsaturated, with aliphatic amines, alcohols or similar functional groups.

11. The water-based anticorrosion composition as claimed in claim 2, wherein the water-based anticorrosion composition comprises 10.0 to 60.0 wt % of fully demineralized water having a conductance of between 0.5 and 5*cm⁻¹ at room temperature.

12. The water-based anticorrosion composition as claimed in claim 2, wherein the oil is selected from the group consisting of a group I oil, group II oil, group III oil, group IV oil and group V oil.

13. The water-based anticorrosion composition as claimed in claim 1, wherein the water-based anticorrosion composition exhibits two-stage filming.

14. The water-based anticorrosion composition as claimed in claim 2, wherein the water-based anticorrosion composition exhibits two-stage filming.

15. The water-based anticorrosion composition as claimed in claim 1, wherein an autonomous gelling takes place after a prior loading, and after a further loading with a high shear rate the water-based anticorrosion composition transitions to a fluid state with reduction in viscosity, preferably wherein the high shear rate \dot{γ} is ≥500 s⁻¹, and/or wherein the water-based anticorrosion composition exhibits rapid gelling at shear rates \dot{γ} of 1 s⁻¹ to 10 s⁻¹ with 1 s≥t≤80 s.

16. The water-based anticorrosion composition as claimed in claim 2, wherein an autonomous gelling takes place after a prior loading, and after a further loading with a high shear rate the water-based anticorrosion composition transitions to a fluid state with reduction in viscosity, preferably wherein the high shear rate \dot{γ} is 500 s⁻¹, and/or wherein the water-based anticorrosion composition exhibits rapid gelling at shear rates \dot{γ} of 1 s⁻¹ to 10 s⁻¹ with 1 s≥t≤80 s.

17. A method for producing a water-based anticorrosion composition having a desired viscosity (η) and/or desired travel distance (TD), comprising or consisting of: mixing 0.1 to 10.0 wt % of a surface-active additive; 0.0 to 5.0 wt % of a functionalized wax; 1.0 to 40.0 wt % of an organic binder; 0.1 to 15.0 wt % of an anticorrosion additive; 10.0 to 60.0 wt % of fully demineralized water (FDVV); 1.0 to 40.0 wt % of an oil; 1.0 to 20.0 wt % of a wax or waxlike substance; 0.0 to 5.0 wt % of a neutralizing agent; 0.0 to 5.0 wt % of a pH stabilizer; and 0.0 to 2.0 wt % of a biocide, based on 100 wt % of the anticorrosion composition.
